(19) United States
(12) Patent Application Publication
(10) Pub. No.: US 2026/0181668 A1
(43) Pub. Date: Jun. 25, 2026

(54) UE METHOD AND APPARATUS FOR TN AND NTN COMMUNICATION

(71) Applicant: Oswego Technologies LLC, columbus, NJ (US)

(72) Inventors: Brian Gordaychik, Columbus, NJ (US); Kazuki Hayashi, Dayton, OH (US)

(21) Appl. No.: 19/378,513

(22) Filed: Nov. 4, 2025

Related U.S. Application Data
(60) Provisional application No. 63/735,988, filed on Dec. 19, 2024.
(60) Provisional application No. 63/750,330, filed on Jan. 28, 2025.
(60) Provisional application No. 63/787,838, filed on Apr. 12, 2025.

(51) Int. Cl. H04W 72/231; H04L 41/5061; H04L 65/1104; H04W 56/00

(52) U.S. Cl. CPC H04W 72/231; H04L 41/5064; H04L 65/1104; H04W 56/0015

(57) ABSTRACT

In an embodiment, a method may be performed by a first wireless device which comprises transmitting a SIP invite towards a second wireless device and receiving information as to whether the second wireless device is reachable via a satellite having an altitude higher than a low earth orbital satellite. The indication is received based in part on information obtained via a satellite network and in part based on information obtained via a terrestrial network. The first wireless device may play audio based on a latency of the satellite and may start a voice based media session, between the first wireless device and the second wireless device, subsequent to playing the audio. The UE may be bound to an independent network slice of the cellular network and may receive one or more key performance indicator (KPI) and/or key quality indicator (KQI) based parameters pertaining to the network slice.

### CROSS REFERENCE TO RELATED APPLICATIONS

This application claims priority to U.S. Provisional Application No. 63/735,988 filed on Dec. 19, 2024, U.S. Provisional Application No. 63/750,330 filed on Jan. 28, 2025 and U.S. Provisional Application No. 63/787,838 filed Apr. 12, 2025, the contents of each of which are hereby incorporated by reference herein in their entireties.

### SUMMARY

In an embodiment, a method performed by a user equipment (UE) operating in a cellular network may comprise processing a subframe comprising downlink control information (DCI), wherein the DCI is located within 4 different symbols of the subframe, in time. The UE may be configured to process variable size DCI payload. The UE may be bound to an independent network slice of the cellular network and may receive key performance indicator (KPI) and/or key quality indicator (KQI) based parameters pertaining to the network slice.

In an embodiment, a method may be performed by a first wireless device which comprises transmitting a SIP invite towards a second wireless device and receiving information as to whether the second wireless device is reachable via a satellite having an altitude higher than a low earth orbital satellite. The indication is received based in part on information obtained via a satellite network and in part based on information obtained via a terrestrial network. The first wireless device may play audio based on a latency of the satellite and may start a voice based media session, between the first wireless device and the second wireless device, subsequent to playing the audio. The UE may be bound to an independent network slice of the cellular network and may receive one or more key performance indicator (KPI) and/or key quality indicator (KQI) based parameters pertaining to the network slice.

### BRIEF DESCRIPTION OF THE DRAWINGS

FIG. 1 is an illustration of a Multi-access edge computing (MEC)-Based advertisement delivery pipeline;

FIG. 2 demonstrates a High-Level MEC architecture for smart home network slicing and microsegmentation;

FIG. 3 demonstrates examples of resource allocation/timing;

FIG. 4 is an example frame format including sensing, discovery, synchronization and acknowledgement elements;

FIG. 5 shows an example synchronization signal transmission designs;

FIG. 6 demonstrates that subframes may be time aligned and partially overlapping;

FIG. 7 is a diagram showing Internet of Things (IoT) devices and an access point (AP) within a non terrestrial network (NTN);

FIG. 8 is an Internet Protocol Multimedia System (IMS) system drawing;

FIG. 9 is a drawing of various Unmanned Aerial Vehicle (UAV) devices in a city;

FIG. 10 is an illustration gaps in satellite and relay transmissions;

FIG. 11 is an illustration of power application in wireless power transfer applications;

FIG. 12 demonstrates core network, base station (BS) signaling and user equipment (UE) signaling examples;

FIG. 13 demonstrates unavailability signaling;

FIG. 14 is an illustration of UALINK switching embodiment;

FIG. 15 demonstrates UALink and NVLink interconnections;

FIG. 16 illustrates two dedicated mobile processors which each have integrated neural processing units (NPUs); and

FIG. 17 is a diagram of an example sensing process.

### DETAILED DESCRIPTION OF THE DRAWINGS

A system is proposed that integrates physical layer approaches, network slicing, microsegmentation, and content-based access control to enhance the security and collaboration of smart IoT networks. By leveraging network slicing, each home or group of homes is assigned a dedicated slice to ensure isolation, bandwidth prioritization, and fair resource allocation. Within these slices, devices such as security cameras, smart locks, and thermostats are further organized into microsegments, creating additional layers of isolation and dynamic policy enforcement tailored to device functionality and security requirements.

The slicing mechanism incorporates principles of Software-Defined Networking (SDN) and dynamic policy enforcement to enable flexibility and independent control of slices. A slicing layer ensures traffic and bandwidth isolation, while programmable network elements allow for management of device-specific behavior within slices. Security cameras, positioned in high-priority microsegments, generate metadata—event summaries including timestamps, locations, and object descriptors—that are processed by gateways hosted in Mobile Edge Cloud (MEC) systems, acting as hubs for inter-slice communications and event coordination. A MEC federator (MEF) organizes multiple MEC systems into a federated network. These gateways facilitate secure inter-slice communication, enabling collaboration between slices while maintaining strict data protection policies.

This paper's architecture is designed to support diverse use cases over a common slicing and segmentation framework. Consider two scenarios: In the first, smart home slice hosting security cameras detects suspicious activity. Another slice, upon noticing a similar event, requests metadata to confirm if it involves the same individual. The system's microsegmentation and secure, temporary tunnels enable cross-slice collaboration, ensuring that sensitive data is exchanged only when necessary and authorized. In the second scenario, the infrastructure responsible for generating metadata from camera feeds is leveraged to support localized advertising services. For instance, if a camera detects a branded delivery box, the corresponding metadata is securely transmitted to an advertising application hosted at the MEC platform. The advertising application then uses this metadata to select and deliver relevant, targeted advertisements to the associated network slice. Throughout this process, strict privacy controls and resource isolation, enabled by the 5G slicing and SDN-based microsegmentation, are maintained. Slices may be created in the smart home system. Software-Defined Networking (SDN) Controllers are responsible for dynamic network management, traffic routing, policy enforcement, and interslice communication. Slices are designed for isolation and resource allocation across homes. The Slicing Home Networks paper by Yiannis Yiakoumis et al. identifies four key requirements for slicing home networks:

Traffic Isolation: Data should not leak between slices; Bandwidth Isolation: Slices should have guaranteed bandwidth, preventing one slice from starting others of resources; Independent Control: Providers should be able to control and manage their slices independently, including modifying network behavior and policies; and ability to Customize and Modify: Slices should support customization to allow providers to innovate and improve services over time.

This design leverages SDN principles, particularly using OpenFlow and an SDN proxy (Network Hypervisor) to implement slicing. We use the architecture provided by Implementation of Network Slicing for Multi-controller Environment Based on FlowVisor by Suadad Mahdi, Alharith Abdullah.

OpenFlow: Programmatically manages traffic flows and configures switches dynamically.

Network Hypervisor: Virtualizes the physical infrastructure to create multiple independent network slices.

Each home in the network may be split into independent, logically isolated virtual slices. These slices are designed to operate as standalone networks, with guarantees for traffic isolation, bandwidth allocation, and independent programmability. Each slice will have its own independent SDN controller, interacting with the underlying data plane using OpenFlow.

A hypervisor creates a number of network slices. Each slice includes a dedicated SDN controller.

A network hypervisor, such as FlowVisor, virtualizes the underlying network infrastructure to create logically isolated slices. By intercepting control messages between the network controllers and switches, it enforces isolation policies and ensures that only authorized flow modifications affect each slice. This prevents one slice's configuration from interfering with another, upholding strict traffic and security boundaries.

Once the hypervisor establishes a slice, it instantiates an SDN controller dedicated to managing that slice. Using OpenFlow protocols, these controllers program the switches to implement forwarding rules and manage resources such as bandwidth and latency. Each network slice is controlled by a separate SDN pox controller to preserve isolation between slices.

Controllers are limited to managing only their assigned slice. FlowVisor inspects and modifies control messages between controllers and switches. If a controller attempts to send flow modification messages outside its flowspace, FlowVisor blocks or modifies these messages. Controllers cannot install, modify, or delete flow entries that affect traffic outside their slice, preventing them from influencing or intercepting other slices' traffic.

As outlined in Section 5.1 of Mahdi and Abdullah, the implementation details how to realize such a network slicing system in practice.

Microsegmentation involves dividing the devices within a network slice into smaller, isolated groups based on their function, security requirements, or other criteria. These groups communicate only with devices they are explicitly permitted to interact with, minimizing lateral movement of data. Each home will effectively be given a virtualized “mini-network” which offers a logical place to integrate microsegmentation logic on a per-slice basis.

Within each home slice, microsegmentation architecture from Transparent Microsegmentation in Smart IoT Networks (Osman, Wasicek, et al.). is applied. According to Osman et al.: “SDN-enabled wireless Smart Home Gateway (SHG): either in the form of new hardware, or realized as a soft switch running on a traditional Residential Gateway (RG) using opensource firmware (e.g. Open vSwitch (OVS) on OpenWRT); Microsegmenter VNF: an SDN application that can re-program the SHG via a protocol such as OpenFlow; Network inventory VNF: in contrast to static annotations, this component fingerprints and identifies devices on the SH using traffic analysis for example. It also scans the IoT devices for vulnerabilities and conducts exploitability assessments.”

To implement microsegmentation within each home network slice, several key building blocks must be put in place. At the data plane level, Open vSwitch (OVS) serves as the foundational switching element. OVS is a virtual switch that provides fine-grained programmability through the OpenFlow protocol, allowing external controllers to dynamically install or remove flow rules. By starting the OVS instance in a default-deny mode, the network ensures that no communication paths are open without explicit policy approval. This approach forms the bedrock of microsegmentation-no device can communicate with another unless the microsegmenter and SDN controller install the proper OpenFlow rules to enable that traffic.

At the control plane level, a Microsegmenter VNF (Virtual Network Function) and a Network Inventory component work together to determine and enforce segmentation policies. The network inventory service identifies devices connected within the slice, classifying them into categories such as cameras, printers, sensors, or potentially vulnerable endpoints. This classification might rely on known device fingerprints, observed traffic patterns, or external vulnerability databases. Instead of designing a new classification method, Osman et al. implemented the Network Inventory by wrapping code from the Avast WiFi inspector. This commercial tool already includes an algorithm for device classification and vulnerability scanning. Once a device's role and risk level are understood, this information is passed to the microsegmenter logic. The microsegmenter uses the classification data and any known vulnerabilities to determine how strictly to isolate the device.

With a device's microsegment assignment decided, the microsegmenter communicates these policies to the per-slice SDN controller, which is responsible for programming the OVS with the appropriate OpenFlow rules. These rules might, for example, only allow certain MAC or IP pairs to communicate, or even only permit specific types of traffic.

Additionally, leveraging a Multi-Access Edge Computing (MEC) platform enhances the scalability and responsiveness of microsegmentation. The MEC nodes, located closer to the homes than a distant cloud, can host the microsegmenter VNF and the network inventory service. Running these components at the edge reduces latency, ensuring that classification updates, vulnerability scans, and policy rule changes can be applied swiftly. The MEC environment can also provide the necessary compute and storage resources, scaling up to handle more devices, running more complex classification algorithms, or maintaining more detailed state without overburdening the home gateway itself.

Cameras operating on independent slices will stream video data directly to MEC hubs via Real-Time Streaming Protocol (RTSP). MEC hubs are responsible for processing the real-time video streams to generate metadata.

Each MEC hub hosts specialized applications capable of decoding video streams using tools such as GStreamer, OpenCV, or similar frameworks. The tools should be able to connect to an RTSP source and decode the incoming compressed video data into raw frames for analysis. GStreamer lets you build a chain of elements (plugins) that handle input, decoding, filtering, encoding, and output. OpenCV provides a wide range of out-of-the-box functions for object detection, facial recognition, motion tracking, and other vision-based analytics. It can integrate with trained AI models to run inference on frames, supporting DNN modules that let one load and run neural networks for object classification. Once decoded, these applications can employ AI/ML models to analyze the video content, extracting actional insights such as object detection, activity recognition, and advertising information. The analysis output is transformed into structured metadata, formatted as JSON objects, which are then managed by the MEC platform.

The generated metadata is both localized and centralized, serving multiple purposes: Local Applications: At the hub level, the metadata is immediately available for applications like advertising services, which match detected objects (e.g., newly identified products) with relevant ad content; Federation-Level Processing: The metadata is also forwarded to the MEC federator through Mp1 and Mff APIs, enabling inter-hub collaboration and higher-level event correlation. This federator aggregates metadata from all connected hubs, creating a centralized repository that supports cross-slice collaboration.

The metadata includes key attributes such as object type, timestamp, location, confidence scores, and any associated event labels. For metadata supporting ads, the video processing application identifies objects, context, or events from the camera feed and annotates them with metadata descriptors (e.g., “person wearing red jacket”, “vehicle with company logo”, “delivered Walmart package”).

The MEC host may run a specialized advertising application that has access to an “ad inventory.” This inventory could be: Locally Stored Ad Database: Pre-loaded advertisement creatives, promotions, and offers from local businesses or content providers; external Ad Network Integration: APIs or interfaces that connect the MEC advertising application to a regional or global ad platform (an external ad server or Demand Side Platform (DSP)).

The advertising application should have a set of rules or an AI model that maps certain tags (e.g., “red jacket” or “sports car”) to specific ad categories. For example, seeing a person wearing a red jacket might trigger ads for apparel brands that have paid for targeting spots relating to clothing or outdoor gear.

Given the sensitivity of video data and the metadata derived from it, all communications must be encrypted using HTTPS and authenticated via OAuth 2.0. Additionally, metadata should be anonymized where necessary to ensure that no personally identifiable information is exposed without authorization.

Inside the MEF, rapid querying of metadata should be implemented to identify related events. APIs for querying metadata based on temporal proximity, geospatial proximity, and attribute matching should be created to match the related metadata. A similarity scoring algorithm can be created to compare metadata field (e.g., object descriptors, movement) and thresholds set for match confidence to minimize false positives. Querying of metadata should only be done if a valid inter-slice collaboration request is approved. Audit logs for all queries should be maintained.

Once the MEC system approves an interslice collaboration request, it acts as the orchestrator for communication between all participating slices. The process involves authorization, secure tunnel creation, data exchange, and cleanup. A requesting slice retrieves only the matched data (e.g., video clip or additional metadata) through the tunnel.

Once the data exchange is complete or a collaboration timer expires, the MEC will notify the SDN controllers to remove the temporary tunnel. The SDN controller reconfigures network elements to terminate the tunnel and the MEC ensures that no residual connections remain active. Any temporary metadata or logs can be deleted unless required for audit purposes.

Metadata may be stored.

Quickly accessible metadata for real-time decision-making is necessary for serving local ads and triggering security alerts. An in-memory data store like Redis, an open-source, in-memory data store that can be used as a cache, message broker, or database, could be used. Being in-memory, Redis provides near-instantaneous retrieval time, allowing any local MEC application (like the advertising service) to query and act on the data without delay.

A NoSQL document store like MongoDB is well-suited for the federator layer because it provides the flexibility, scalability, and ease of management needed for short-term historical metadata. Unlike relational databases, MongoDB does not require a predefined schema, allowing metadata fields to evolve over time as device types, detection models, or analytic requirements change. Its document-oriented model lets you store each event, object detection, or activity log as a self-contained record, simplifying queries and enabling efficient indexing on the attributes most relevant to analysis. MongoDB also scales horizontally, accommodating increased data volumes as the system grows to include more MEC hubs and slices. Additionally, it offers integrated support for replication and sharding, ensuring consistent performance and fault tolerance. With built-in features to set retention policies, data older than 30 days can be easily purged.

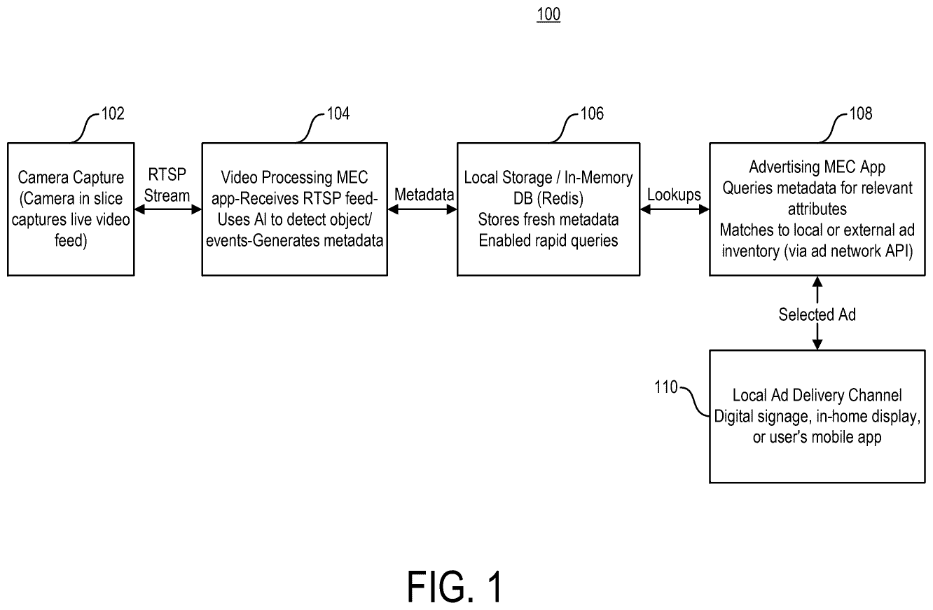

FIG. 1 is an illustration of a MEC-Based advertisement delivery pipeline 100. In an embodiment, a camera or set thereof may capture 102 live video feed. The feed may be provided via RTSP to a video processing MEC app 104. Metadata may be provided to local storage 106 such that fresh metadata may be stored so as to enable rapid queries. Lookups may be performed by an advertising MEC app 108 and local ad delivery 110 may be provided by way of digital signage, in home display or on a mobile phone via an app.

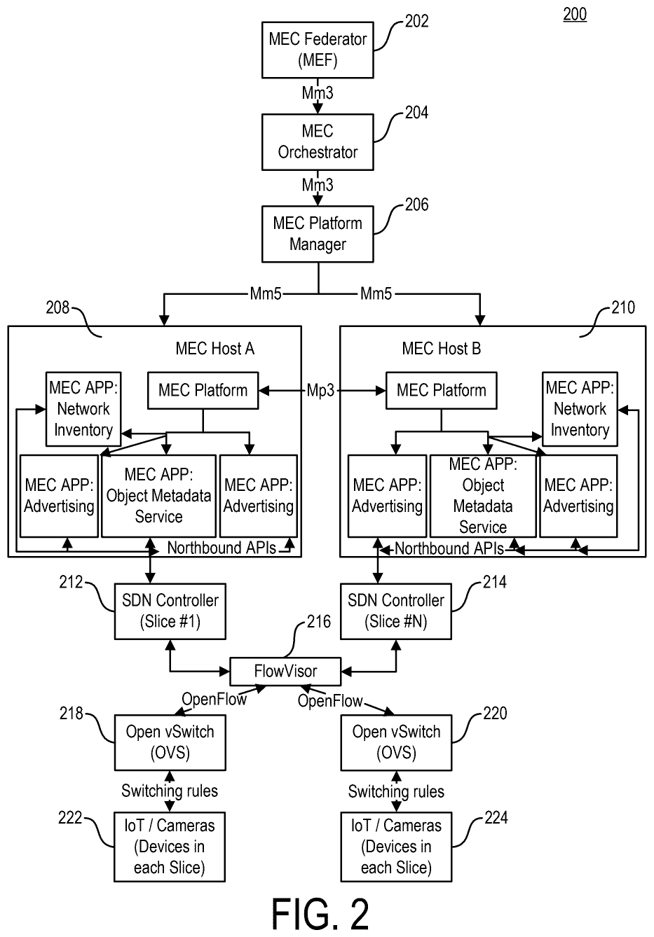

FIG. 2 demonstrates a High-Level MEC architecture 200 for smart home network slicing and microsegmentation.

The system will use a single MEC federator (MEF) 202 with multiple MEC hubs. The MEC federator 202 is the central management entity that oversees inter-hub coordination, policy enforcement, and cross-slice collaboration in a distributed hub-to-spoke topology. The MEF 202 is inputted data from multiple sources. These include the metadata from multiple MEC hubs, slice management information, policy/security data, and status updates.

The federator 202 is responsible for aggregating metadata from multiple MEC hubs, creating a searchable database for quick event correlation, and matching capabilities to compare metadata from different slices to identify cross-slice events (e.g., tracking a suspicious individual across zones). SQL or NoSQL databases should be established for metadata. It is also responsible for checking the validity of a slice collaboration request as well as instructing the SDN controller to establish VXLAN tunnels for inter-slice data sharing.

### MEC Hub and Federator Communication

MEC hubs 208, 210 will communicate with the federator 202 using Mff APIs (ETSI GS MEC 040) for metadata aggregation and coordination via MEC orchestrator 204 and MEC platform manager 206. This interface facilitates metadata submission, query operations (e.g., MEC hubs request information from the federator), and event-driven updates, including updates for time sensitive events or cross-slice collaboration requests. MEC hubs operate independently within their localized domains. The federator acts primarily as a coordinator for inter-hub and inter-slice collaboration. MEC hubs 208, 210 rely on the federator 202 only for global tasks (e.g., inter-slice data sharing or collaboration validation) but not for their core operations. The messages would be encapsulated by a RESTful API: JSON message sent over HTTPS.

In the event that a slice hosted on a MEC hub detects the need for video data from a slice on another hub, the request is sent to the local MEC platform, which forwards the metadata and request to the federator via the Mff API. The federator 202 evaluates the request to ensure it complies with predefined policies (e.g., QoS). The federator 202 checks the metadata of the slices involved and confirms the validity of the collaboration. Upon validation, the federator issues a command to the SDN controller to create a data plane tunnel between the slices. The command specifies: Source and destination slice identifiers, QoS requirements (e.g., bandwidth, latency), security configurations (encryption). FlowVisor 216 may virtualize the network infrastructure and Open vSwitch (OVS) 218, 220 serves as the foundational switching element for IoT cameras 222, 224 in each slice.

The Mff API acts as the interface as the interface enabling coordination, discovery, and information exchange between local MEC hubs and the federator. Below are key functionalities of the Mff API:

### System Registration/Update/Deregistration

Hubs register themselves with the federator using the POST method on the system_info resource

Updates to the system metadata (e.g., available service or status changes) are made via PATCH requests

Deregistration requests are sent via DELETE operations when the hub is removed from the federation

### Service Discovery

Hubs query the federator for available MEC services in the federation using the GET method on the services resource

### Application Instance Management

Hubs use the API for onboarding and updating application package information via the federator

Requests include metadata about application instance status, available resources, and required dependencies

### Subscription to Notifications

Hubs subscribe to updates from the federator, such as service status or federation events, using the POST method on the subscription resource.

Communication uses RESTful design principles, with the following key elements:

### JSON-based Data Structures:

Requests and responses use well-defined data types such as SystemInfo, FedServiceInfo, and NotificationSubscription

Example attributes include:
systemName (name of the MEC hub)
serviceName (specific MEC service name)
callbackReference (URI for notifications)

### Authentication and Security:

All communications are encrypted using HTTPS

OAuth 2.0 is used for authentication for secure access to the federator

### Event-Driven Updates:

The federator can push notifications to the subscribed hubs when significant events occur (e.g., service availability changes)

Subscription resources in MEC Federation APIs are designed to enable event-driven communication between different entities in a MEC federation. These APIs allow entities like

MEC Orchestrators (MEOs) to subscribe to specific events and be notified when something changes.

### 1. Subscriptions (/Subscriptions)

GET: Retrieve all subscriptions for the requester.

POST: Create a new subscription for federation event notifications.

### Request: Use SystemUpdateNotificationSubscription.

Response: 201 Created with the subscription URI.

2. Individual Subscription (/subscriptions/{subscriptionld})
GET: Retrieve details of a specific subscription.
PUT: Update the subscription (replace semantics).
DELETE: Cancel a subscription.

### MEC Applications

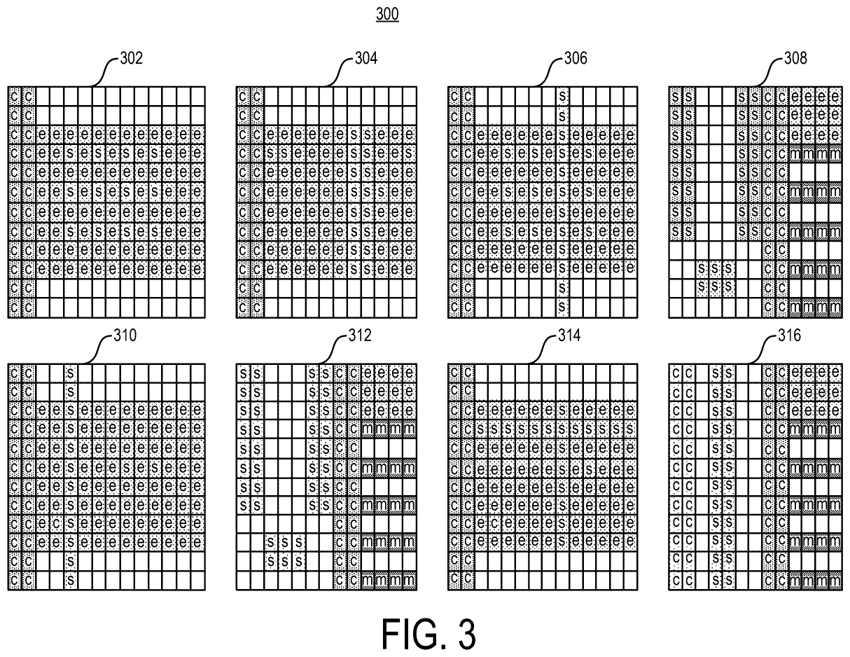

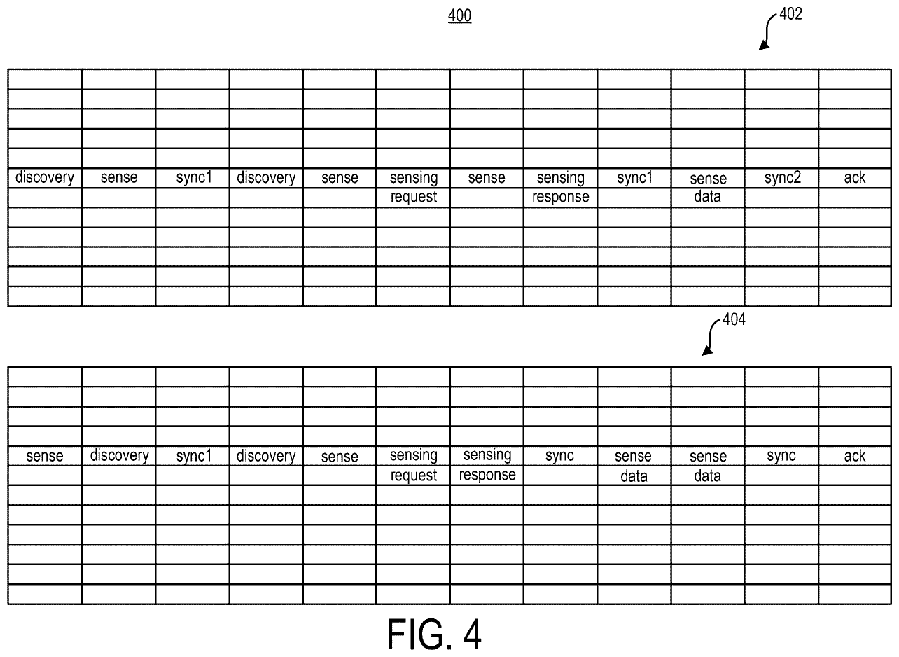

Each MEC hub in the system architecture operates as a MEC host in FIG. 3. The hub contains MEC apps that interact locally with end-user devices and services. The MEC platform services are used to register, manage, and host localized apps for specific use cases. The MEC application can aggregate raw video data, and forward generated metadata to the MEC federator for higher-level processing. Each of this system's applications can be seen in the high-level diagram provided in FIG. 4.

MEC apps communicate with the MEC platform using MEC service APIs available via Mp1 interface. Clause 5 introduces the MP1 reference point as defined in ETSI GS MEC 011. The hubs use Mff APIs to submit metadata or make coordination requests. These APIs align with the Mm5 and Mm3 interfaces in the diagram, enabling communication between the MEC platform, the platform manager, and higher-level systems like the MEC federator.

A MEC application for handling video processing and metadata generation will be created. The metadata generated by the central MEC app is published as a service to the MEC platform via Mp1. The central MEC app publishes its capabilities (e.g., “Object Metadata Service”) to the MEC platform. Other MEC apps can subscribe to this metadata service, leveraging its output.

Another MEC app will be created, which would directly subscribe to the metadata service for localized ad-matching purposes. It consumes the metadata generated by the video processing application. By matching identified objects, events, or product sightings in the video streams to pre-defined categories of advertisements, this app can deliver relevant promotional content. The app will utilize a locally stored ad database or interact with external ad network through APIs.

Real-Time Streaming Protocol (RTSP) can be used to establish a direct connection between the camera and an MEC application, providing real-time video feeds. Each camera operates within its assigned network slice (managed by an SDN controller 212, 214). The MEC app is responsible for generating metadata for the video feed. The MEC application receives RTSP video streams, decodes the stream (e.g., using GStreamer, OpenCV, etc.), and runs AI/ML models to analyze videos and generate metadata. This metadata output is structured in JSON format to be forwarded to the MEC platform as a service via Mp1, and from the MEC platform to the federator using Mff APIs.

To implement microsegmentation within each home's network slice, two key components—the microsegmenter and the network inventory service—can be deployed as MEC applications at the hub level. The Network Inventory application is responsible for identifying and classifying devices connected to a particular slice. This app can either leverage existing modules like Avast Wi-Fi Inspector code or similar scanning tools to determine a device's category and assess its vulnerability level. Within the paper, Avast Wi-Fi Inspector code examines traffic patterns and device characteristics to categorize connected IoT devices. By referencing a regularly updated database of known exploits and security flaws, the inspector identifies potential weaknesses in the communication protocol. Once a device's characteristics and security posture are understood, the inventory application provides this data to the microsegmenter.

The microsegmenter application then uses this classification information to determine how to segment the slice's internal network. Adopting a default-deny stance, the microsegmenter instructs a slice's SDN controller, using standardized APIs, to install specific OpenFlow rules in the home's OVS instance. These rules ensure that only authorized communications occur between devices. Methodologies to apply this can be found in Osman et al. [1].

### MEC Orchestrator

The MEC Orchestrator (MEO) acts as the operational backbone for individual MEC hubs, enabling the Federator to focus on higher-level tasks. The Federator relies on the MEO to provide real-time data about the state of the MEC hubs and applications. The MEO is also responsible for the deployment and termination of an MEC app. It serves as a bridge between the MEF and MEC hubs. The MEF aggregates metadata from multiple hubs and uses this information to guide the MEO in making orchestration decisions. For instance, if the MEF identifies a cross-slice event, it notifies the MEO through the Mfm reference point to communicate with the SDN controller regarding inter-slice communication. It will take instructions from the MEC federator when interslice data sharing is required. The MEO can send the message over a secure channel (HTTPS, TLS) using a message format like JSON to set a virtual link between two slices for communication. The SDN would send back an acknowledgement of this request.

Below is an example of a simple JSON-based message exchange over a secure channel (e.g., HTTPS/TLS) between the MEO and the SDN controller to establish a VXLAN tunnel. The specifics (endpoints, parameters) can vary depending on the actual implementation:

| | |
|---|---|
| | POST/api/v1/tunnels |
| | Content-Type: application/json |
| | { |
| | “action”: “create Tunnel”, |
| | “tunnelType”: “VXLAN”, |
| | “source Slice”: “slice A”, |
| | “destination Slice”: “sliceB”, |
| | “tunnelParameters”: { |
| | “localIPAddress”: “10.10.1.1”, |
| | “remoteIPAddress”: “10.10.2.1”, |
| | “vxlan VNI”: 1001, |
| | “encryption”: true, |
| | “qosRequirements”: { |
| 1. | “bandwidth”: “100Mbps”, |
| 2. | “latency”: “low”, |
| 3. | “priority”: “high” |
| 4. | } |
| | } |
| | } |

Mobile and stationary devices may report a capability to perform radar based and communication based sensing. The capability may indicate whether a same or different circuitry is utilized for each process. Any devices herein may provide capability information suggesting support for one or more services as disclosed herein.

Devices may prioritize sensing or communication resources when necessary for packet dropping policies, for transmission conflicts, etc. A priority level, e.g. level 1-10 (1 being highest priority, 10 being lowest), may be used for sensing, as compared to transmit priority levels for communication. The priority level(s) may be in accordance with sensing resources of a given communication scheme, for example, time resources, frequency resources and beam resources. Such resources may be selected based on a type of sensing performed. Devices may prioritize sensing over V2X communication, but when an existing V2X grant is configured, the V2X communication resources may double as sensing resources. A table is provided below which shows example devices, actions performed, subactions (based on the action) and a corresponding priority level for each action.

TABLE 1
Device action datum

| Device | Action | Subaction | Priority |
|---|---|---|---|
| Vehicle | Driving | Detect human | 2 |
| Vehicle | Driving | Crash detection | 1 |
| Vehicle | Driving | Lane monitoring | 6 |
| Vehicle | Driving | General, e.g. pool | 10 |
| | | based | |
| Vehicle | Driving | traffic alerting | 8 |
| Vehicle | Driving | blind spot checking | 3 |
| Vehicle | Stationary | Performing relay | 8 |
| | | function | |
| Landscape object (lamp | Emergency alerting | Relaying siren signal | 1 |
| post, sign, road cone, | | | |
| etc.) | | | |
| Landscape object (lamp | Monitoring traffic condition | Counting cars | 3 |
| post, sign, road cone, | | | |
| etc.) | | | |
| Landscape object (lamp | Environmental monitoring | Icy or hazardous | 2 |
| post, sign, road cone, | | condition monitoring | |
| etc.) | | | |
| Landscape object (lamp | Performance of a function | Video relaying | 7 |
| post, sign, road cone, | instructed by a vehicle or | | |
| etc.) | drone | | |
| Landscape object (lamp | Performance of a function | Conveying stop light | 9 |
| post, sign, road cone, | instructed by a vehicle or | status | |
| etc.) | drone | | |
| User Worn Glasses | In motion | Detecting crosswalk | 2 |
| | | entrance | |
| User Worn Glasses | In motion | Navigation | 8 |
| User Worn Glasses | In motion | Detecting people | 5 |

A variable number of symbols may need to need occupied for the sensing component of ISAC. It may be that one, two or more symbols are occupied for sensing, separated in time by communication resources. Such symbols may or may not be consecutive (for example, when a sensing range exceeds a communication range). Devices may signal a priority to perform ISAC and if a certain device is discovered, via a discovery procedure, on a given frequency/time/beam resource, the lower priority device may cease ISAC for a period on certain resources, based on a threshold location/beam of the other higher priority device. Devices may also prioritize a plane of view for processing, for example, processing and rendering a street view prior to processing a view at a higher altitude.

Utilization of sensing resources may or may not be in accordance with a resource grant. For example, assuming a resource grant is eMBB based, based on the diagrams below:

FIG. 3 demonstrates examples 300 of resource allocation/timing. Example 302 employs control resources on first time resources and eMBB resources having sensing resources scattered. Example 304 employs control resources on first time resources and eMBB resources having sensing resources scattered differently. Example 306 employs control resources on first time resources and eMBB resources having sensing resources in yet another pattern. Example 308 employs sensing resources on a subset of first time resources, control resources follow and eMBB resources and mMTC resources follow. Example 310 is similar to example 306 yet lacks additional single placed sensing symbols. Example 312 is identical to example 308 and may be used more frequently in some scenarios. Example 314 is similar yet not identical to example 306. Example 316 is similar yet not identical to examples 312, 308.

In the examples, c denotes control, e denotes eMBB, s denotes sensing, m denotes mMTC. Resource allocations may be performed based on a priority of the sensing function and/or based on a latency requirement to have the sensing result. For example, if a sensing procedure must be sent immediately and driven over a particular frequency/time/beam, then it may occupy more than 1, 2 or more symbols in time. A two symbol allocation may be necessary in conditions where a sensing target is at a cell edge, so as to allow for time to receive the sensing response (which may indicate velocity of the responder such that the transmitter may increase or decrease sync symbols including dmrs symbols). Such sync symbols may be maximum length sequences (m sequences) shifted or xored forming gold sequences. Different shifts or different sequences may be used in different frame formats and/or for joint transmission or combined transmissions, each transmitter may transmit a same frame content except for varying mark sequences which may or may not be followed by one another such that each transmitter blanks during the other transmitters mark sequence. In some embodiments, sensing may be performed in order to establish a location of subsequent control information, and/or allocation information in the time, frequency, beam data base transmission. Sensing based transmission resources may take priority over mMTC, eMBB and potentially URLLC resources assuming the sensing resources are destined for a same URLLC target device.

Certain devices may perform transmit sensing and/or receive sensing in a guard band of a SBFD slot. Other guard portions may be used to jointly convey any data herein and/or sensing signals. The ability of a device to perform sensing transmission within a guard interval may be conveyed from a BS to UE, UE to BS or UE to UE. For instance, a first slot may be UL, second slot may be DL, third slot may be UL-SENSE-DL, fourth slot may be UL, fifth slot may be DL and sixth slot may be DL-SENSE-UL. Other options are applicable.

Prioritization of ISAC over other services/signals may be employed by any device herein. For example, if a device needs resources to perform sensing, the network may transmit a cancellation indication indicating resources which are cancelled, to other UEs, in the same or a different grant that conveys resources to the UE or UEs which need to perform sensing. Alternatively, or in combination, resources may be scheduled for sensing subsequent to their allocation for data services, via same or subsequent DCI. Such resources may be repurposed entirely, or used for joint data transmission/sensing transmission. If resources are used for reception purposes, those receive resources may jointly be used for data reception and sensing signal reception (from a same or different node as the data is received from).

URLLC may be integrated so as to avoid scheduling ISAC signals during periods which transmit sensing and receive sensing signals are expected.

Base stations may negotiate allocating resources for sensing vs. communication. The BS can provide a pool of resources for use for sensing, transmit, sidelink, etc. A base station may provide a resource pool to a UE such that the UE can provide a same resource pool or another resource pool derived from the resource pool to another UE to perform sensing (among other transmission/reception) on the resources or subset of resources.

ISAC can be utilized for RACH.

Devices may transmit a variable number of pilot symbols for ISAC, for instance, using variable placement in the time/frequency/beam domain. The number of pilot symbols may be increased based on correlation between sensing/communication and a number of pilot symbols may be conveyed for a particular transmission by using a coded sequence. Pilot symbols may be integrated into a transmit signal when UEs are below a capability or threshold or cannot be identified via integrated sensing. Communication, ISAC and sensing may use a same TDD channel separated over time and frequency.

Devices and other elements being searched for may be found or may not be found, so sensing when the device location is unknown (how many resources) vs resource utilization when device has been coarsely located vs. located via a reference signal (so good idea where it is).

Sensing resource allocations may be prioritized among other sensing resource requests.

Sensing may be prioritized over a need for data resources.

In an approach, resources may be time/frequency beam separated.

ISAC resources may be allocated in a URLLC mode, eMBB mode, and/or a MMTC type mode, based on capability and/or priority.

Devices (mobile and/or stationary) may send requests to other devices (mobile and/or stationary) to perform sensing functions on behalf of the requesting device or another device. In embodiments, a discovery procedure may be performed, either using network resources, absent any network allocated resources, or using some preconfigured network allocated resources and optionally some non-preconfigured resources. In embodiments:

A method performed by a mobile wireless device may comprise: determining that the mobile wireless device is in need of sensing information in a particular direction or area; determining, by way of sensing in the particular direction or area, that other mobile wireless device(s) are in in the particular direction or area AND/OR transmitting a request and receiving a response to/from one or more of the other mobile wireless device(s) are in in the particular direction; determining a capability information pertaining to certain devices of the set and determining whether one or more device matches a capability desired; transmitting control information to at least one device indicating: resources for performing sensing; a sensing direction, desired sensing object properties; latency information for responding back with the sensed information, resource information for a response, group resource information for conveying the sounding information to one or more other users; and any other information as described herein. Wherein the sensed information comprises information indicating the position of one or more pedestrians, vehicles, buildings, one or more roadway conditions, an ambient condition or other parameters herein. On a condition that the sensing device is not capable of performing a certain sensing procedure, instructing the sensing device to perform a software upgrade.

The method may further comprise sending an allocation request to one or more base stations, by the sensing device, requesting a resource grant to perform the sensing requested and receiving a resource grant for both performing the sensing and communication of sensing results.

A first device may broadcast a message in a certain direction, wherein the message includes data and sensing transmissions, for example, a same slot includes both sensing resources and communication resources such that the slot is used for device discovery based on sensing and device discovery based on a request/response model. Elements of the message may be relayed to other devices in range of a recipient.

When a sensing device receives a sensing request from another device, the sensing device may review latency information included in the request and evaluate whether or not sensing can be performed in the time requested. If it cannot, the device may drop the request or transmit a response indicating unavailability. Priority information and latency information included in the request may indicating to the sensing device whether to not transmit on potentially overlapping resources and instead utilize the sensing resources and/or communication resources for performing sensing/communication and responding to the requestor. Devices that receive a request for sensing may reject the request based on security or access requirements/rules, capability, batter life, protocol support, an ability of another device nearby that can handle the request. The another device that handles the request may signal to other devices that receive the request that the request is handled. Any group messaging may be performed via control information having a group based RNTI and any individual signaling may be performed via control information having a device unique based RNTI.

Combined sensing information and data may be sent, by a UE or other device using a pre-configured resource pool when the UE is in network coverage or when the UE is out of network coverage or when the UE has an emergency type request (e.g. determining whether there is an emergency ahead). In some embodiments, the pool may be broadcast via SIB and may be used before, during or after connection establishment with a network. In emergency situations, the pool may be used even though a device is not associated with a cellular network or the cellular network operator of the transmitted SIB. Open or closed loop power control may be enabled based on negotiation parameters between UEs, UE and base station, etc. There may be situations wherein a UE cannot find a cell that supports the allocation of dedicated sensing resources and may in this case use other preconfigured resources or perform resource selection autonomously based on a discovery procedure in which the UE detects whether certain time/frequency/beam resources are available for it to use.

Base stations may perform cell directional restriction, for example, by allocating sensing pools only in certain directions and/or by indicating pools for certain areas. In this way, the UE may receive a pool and select a subset of resource for use in sensing and a subset of resource for indicating to another UE to perform sensing on the first UEs behalf. The resource may include data transmission resources for sending a request, and sensing resource for performing sensing both by the first UE and second UE. The first UE and second UE (among other UEs) may be part of a group of UEs that are traveling in a same area, same direction and may receive a new resource pool for data and sensing resources as they enter the coverage area of a new station. Each device in the group may jointly receive certain information and individually receive other information. Each device in the group may jointly send certain information and individually send other information. Resources (pool, dedicated, individual, etc.) may be allocated by sending a buffer status report.

FIG. 4 is an example frame format including sensing, discovery, synchronization and acknowledgement elements. Specifically, FIG. 4 demonstrates two different D2D frame formats 402, 404, which may also be used by base stations, relay devices, etc for requesting sensing to be performed device to device. Alternative frame formats may be SBFD types depending on capability of the receiver. SBFD d2d transmissions may include resources dedicated or earmarked for sensing of the transmitter of the frame or a receiver of the frame. A sensing based RNTI may be employed for group and/or individual control channel transmissions. Different frame formats may be used for different types of sensing transmission, i.e. some frame formats may be modulated in whole or in part using linear frequency modulation (LFM) and/or frequency modulated continuous wave (FMCW) modulation in combination with other modulation techniques described herein. The frame format may specify inherently or explicitly a type of modulation to be used for sensing. Frame formats may specify a number of variable time/frequency domain resources to employ or that are employed in a frame. Certain frame formats may be employed by certain SIMs or for certain carrier aggregation scenarios, while others are not employed in such scenarios. A number of time/frequency resources used for sensing may be based on a randomness of data transmissions interspersed within the time/frequency resource allocations. In the above frame format, sync may or may not be repeated sequentially to cover up to 6 symbols in the time domain and may or may not be separated in the frequency domain per symbol such that a highest resource block is not lined up with a highest resource block in a subsequent symbol and a lowest resource block is not lined up with a lowest resource block in a next subsequent symbol. The length in time, e.g. number of symbols used for sync or other symbol, may be increased or decreased based on express feedback from a UE or derived based on sensing results (about the UE).

In embodiments, a relay node UE may receive receiving a physical sidelink shared channel (PSSCH) transmission comprising a sensing request, from a first device; transmitting the sensing request to another UE and determining whether the another UE received the sensing request successfully; on a condition the sensing request was not successfully received, ramping the power for a retransmission of the sensing request; on a condition the sensing request is still not received successfully, reducing the power and sending the sensing request to another UE, based on information contained in the sensing request. The information contained may be a list of UEs, group of UEs, UEs in an area or direction, may comprise broadcast discovery information, latency information, power control signaling, alternative UEs, UE capability minimum thresholds, location information, etc. Requests may include information about the transmitting vehicle, requests for information about the receiving vehicle and requests for information about the surrounding vehicles and/or area, including speed, direction of travel, velocity, acceleration, brake like detection.

Synchronization signal blocks (SSB) may be utilized to provide joint reference signal transmission, for purposes of sensing or other reference signals, that also convey certain synchronization or data. In embodiments, a PSS and/or SSS may be formed from such a sequence (M-sequence, etc.) such that certain resource elements serve both for synchronization purposes and sensing purposes. The placement of the resource elements within a sequence may depend on a cell identifier or other information element which is being conveyed to a UE. It may be that certain reference signals, e.g. sensing signals, are embedded within the PSS, SSS, PBCH, or other element of an SSB, and due to these elements, there may be necessary gaps of no transmissions in subsequent symbols by a transmitter, or in same or subsequent symbols of another nearby transmitter (e.g. in a cell free scenario or distributed mimo scenario). Sensing symbols may be included in certain horizontal or vertical directions and not their vertical or horizontal counterparts, in embodiments, wherein sensing is desired in certain horizontal or vertical dimensions only. The same may be true for when a device needs to sense a particular area or beam direction, but not another area or beam direction. SSBs may be synchronized, over the air, between base stations.

In 6G systems, a synchronization signal may not be as fixed as in 5 g. for instance, some devices may be capable of sensing, while others are not. In embodiments, a PSS, SSS or other element of a SSB may vary in number of symbols in time or number of resource elements in frequency. Based on a certain shifted sequency, the UE may ascertain the cell id and either perform a capability lookup from the cell ID, or from a portion of the cell ID, the UE may ascertain capability, e.g. based on a table or other means, and that table may direct the UE to how to decode the remaining SSB elements. The table may indicate capability of sensing and indicate resource elements that are used for reference signals, sensing signals, etc. to perform demodulation/decoding of subsequent elements of an SSB or future SSB.

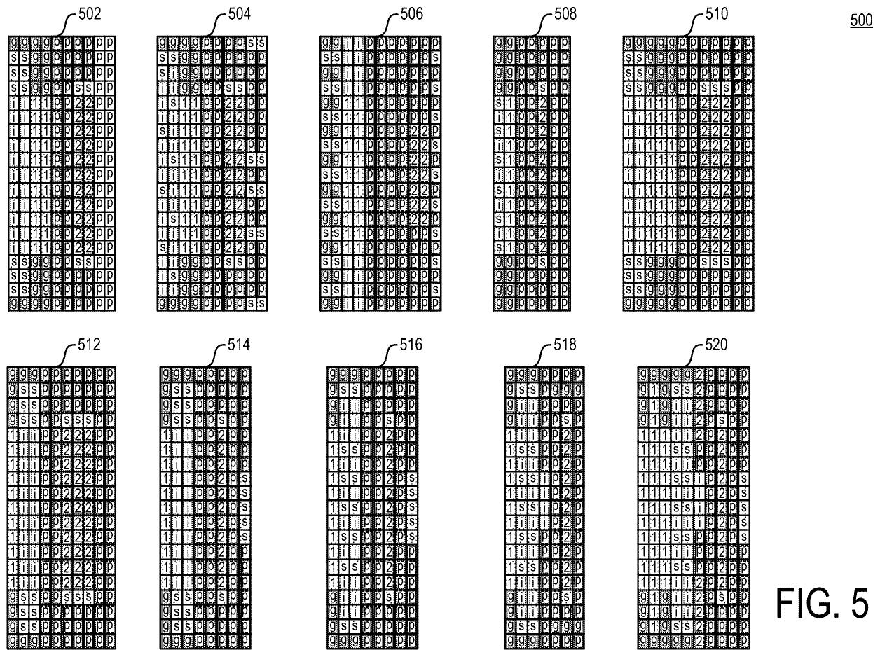

FIG. 5 shows an example synchronization signal transmission designs 500. Examples 502, 504 are 10 symbols long and locate initial sync symbols up front. Example 506 is 11 symbols long and locates sensing and guard symbols up front. Example 508 is 7 symbols long and dedicates fewer resources for the initial sync signal among other signals. Example 510 is longer in time (12 symbols). Example 512 locates a primary sync signal before an initial sync signal. Example 514 is similar, yet not identical to example 512. Example 516 is similar yet not identical to example 514. Example 518 is a shorter in time variant and example 520 is a longer in time variant.

In the examples, (i) is represents an initial sync signal that conveys information about: the size #resource elements, number of slots, repetition pattern, contents, subsequent ssb designs, signal placement, reference signal frequency/time pattern, placement of guard signals and/or other information about the SSB structure, design and time/frequency/beam arrangement or placement. (g) represents a guard or no transmit resource, (s) is for sensing reference signal transmission/reception; (p) is for pbch data or dmrs (dmrs may be scattered throughout the PBCH segments like in 5G); (1) is primary sync and (2) is secondary sync. The initial sync signal may be derived from a shifted sequence with a seed known to both UEs and other base stations. The initial sync signal may be placed before, after or within a 5G sync signal such that a receiver may determine whether the BS is transmitting according to a legacy design or is implementing a new design. Certain formats may have displaced reference signals from other designs. An adaptive SSB approach may provide different SSB signals in the horizontal/vertical direction based on sensing need. So some USs may have certain expectations, while others may expect more or less reference signals and more or less dedicated symbols. It may be that reference signal density is increased per a counter basis, and indicated in a certain symbol of the SSB or derivable via the SSB itself or via a previous SSB. Muting patterns are not described above, but devices may negotiate muting patterns that mute entire SSB symbol(s), frequency components, uplink or downlink components of SBFD elements of the SSBs, etc. as is necessary due to detecting of conflicts or for performance of measurements at UE side, relay side, BS side or for other devices.

SSB symbols that are used for sensing may be transmitted by a certain device, e.g. a RRH or UE, and received by another device, on resources of the another devices SSB, on the condition that two devices are time/frequency/beam synchronized. Two of the same RRUs of a base station may act as a sensing transmitter/receiver in embodiments and SSBs may be transmitted per RRU accordingly. In embodiments, a sensing transmission device may send signals for reception by another sensing receive device, the sensing transmission may be interleaved with time/frequency/resource allocation information for receiving sensing feedback information from the sensing receiver. Pilot signals incorporated into SSB bursts may or may not be sent in a same direction or beam as data sent in an SSB block. For example, the sensing signal transmissions of an SSB may be sent using a next beam in a sequence of beams transmitted in a sequence of beams used for SSBs.

In some embodiments, stations may front load symbols in an SSB. In those front loaded symbols, sensing symbols may be integrated that may serve dual purposes, e.g. sensing and data communication and may or may not be used for demodulation and reference purposes. Some symbols of an SSB may need to be preempted and/or blanked in certain beams/transmission directions when a full duplex transmitter, e.g. a plurality of full duplex remote radio heads, are employed. In embodiments, some radio heads may be full duplex, while others do not have the capability of performing full duplex communication and thus may be time duplexed (or may use another duplex method).

In some embodiments, preambles may be dedicated to sensing or other purposes in an SSB symbol or other symbol. It may be that a preamble based sensing approach is used in place of or in combination with SSB sensing when there exists ample resources for doing so, when SNR is above or below a threshold, when sensing latency is above or below a threshold, when additional sensing need is above or below a threshold in a direction or area. An adjusted preamble periodicity may be performed when sensing is or is not required. In SSBs or other symbols, there may be code domain multiplexed information which is multiplexed with data or sensing symbols. Such symbols may be known to the UE or conveyed via a reference signal, e.g. the reference signal provided above. The same or different reference signals may indicate how to differentiate pilot transmissions from control or data transmissions, and how to use the pilot to provide feedback. Any of the above embodiments may be used in cell free conditions and 3D beamforming conditions, wherein when joint transmission of an SSB is applied, one transmitter may blank certain Res such that the other can perform receive based sensing. Multiple antenna arrays transmit a signal to scan horizontal and then vertically, with broader beams as different vertical heights followed by narrower beams at those verticals.

Resources used for SSB may be punctured for use by URLLC applications. For example, if a device needs data in the uplink or downlink, while an SSB is being transmitted, then it may be that certain symbols of the SSB are dropped in favor of allowing the downlink or uplink data transmission to take precedence. In cases where the initial sync symbol is overwritten, it may be shifted in time. Alternatively or in combination, in cases where the initial sync symbol is transmitted, but subsequent information is punctured, the sync symbol may convey puncturing information so as to inform other UEs that the SSB contents which follow are not typical and to expect different information on a next beam cycle. The initial sync may convey a set of preambles available for UEs in that direction or beam. Information about the initial sync may be provided via v2x or UE to UE communication via a direct link. Sensing signals and/or the initial sync may be used for power estimation and control by the UE measuring the signals and reporting a receive power.

SSBs may be modified to include or provide a pointer to any one or more parameters outlined in 3GPP 38.331 v 18.3.0 uploaded on Sep. 25, 2024 (disclosed herein by reference in its entirety). Any one or more of the parameters may be conditionally included, for example, as may be indicated by another element in the SSB and/or the element(s) may be of a different size than specified in 38.331, for example, a decreased number of bits may be used to convey the same amount or less information. SSB transmitting and sweeping may be performed at the UE side, base station side and/or relay side (in accordance with one or more other sides, for example, by aligning reference signals and beams among pairs.).

There are many applications involving integrated sensing and communications. One such application involves utilizing ISAC for integrated circuit and/or product testing. In embodiments, an ISAC transmitter may provide power for powering a circuit, data for controlling a circuit (including input parameters, breakpoints, debugging information, etc.) and sensing signals for identifying issues in the mechanical or electrical configuration of the circuit. ISAC resources may be utilized from a single transceiver or via multiple transceivers placed in serial or in parallel with a circuit or multiple circuits such that different transceivers can control, view the status of, and power different types of circuits and/or different portions of the circuit. Each transceiver may communicate with one another about a status or fault issue, such that one transceiver may be aware of a potential problem that may affect yield. So, if a subsequent ISAC transceiver identifies that the existing problem or issue is carried forth or is further identified or has an additional issue that exceeds a threshold, the subsequent transceiver may identify the circuit for discard. Alternatively, the transceiver or group of transceivers may identify the circuit as being in accordance with a successful test performance. Radar infused cameras may also cooperate with transceivers to identify physical issues, for example, when incorporated into a drone or other object. Detectors may be microscopic when used for tracking errors in an object through the manufacturing stage. Detectors may look for particles which contaminate the manufacture, outputs which correspond to the wrong input settings selected for a manufacturing batch or other issues. Certain resources, of simultaneous transmissions, may provide power, sensing transmissions, reception transmission and data transmissions.

Other embodiments may be used by a cell phone with an off-the-shelf type ISAC sensor. For example, for performing home inspection imaging to find signs of termite damage, sagging joists, weakened loading, asbestos materials, material sampling from imaging and radar studies, air particle monitoring, snaking of devices, looking at/finding cracked pipes, bad solder joints, and/or may be employed in underground tank detection. Reports may be automatically generated based on information identified via camera and ISAC sensor.

Ability to expose camera information via a capability request/response which is transmitted locally, for example, at a given power level using a particular protocol or protocols. For example, one home may transmit a capability request/response to determine cameras in a certain range. The system may broadcast a cooperation request to neighboring camera systems to allow for video cooperation. Extensible Markup Language may be used to provide capability and cooperation parameters.

In a capability request, a device may provide certain information about the requesting device. E.g. a household may have x cameras at y locations in z directions. Such information may be provided in the request. Alternatively, or in combination, an image or images may be provided to demonstrate the viewing angle, direction or scene so that a receiving device may provide such information to an operator for acceptance. In this way, a handshake procedure may occur by which one neighbor allows sharing of real time video/sensing information with another neighbor based on what the other neighbor has.

For example, take two neighbors across the street from one another. Each neighbor has cameras that point in the direction of the other neighbors house. Both neighbors would like access to each others cameras. One neighbor may use a particular protocol to initiate a connection request, for example, Bluetooth, Wi-Fi, etc, and if no connection is established, another protocol may be attempted. Each protocol may rely on beaconing to advertise support for a particular protocol. Beacon messages may establish resources, security information, and the like for another neighboring device to establish a connection. Security checking may be in the form of a password or non-password based security protocol. By sending a capability request, an establishing device may provide access to video feeds, which are current, and viewable by the device(s) having a capability requested. In this way, a receiving device may confirm the identity of the requesting device, by viewing the video feed and comparing such video feed to video for which it is currently monitoring. In examples, if both a requestor and responder view a red car having license plate number XYZ-123 at a particular time instant, then the responder may confirm that the video feed is accurate and timely and may automatically or manually allow access to certain video images at the neighbors side.

Phone apps may be used to share video camera access, photographs and video footage. Friend requests may be made electronically and sharing permissions may be granted to friends, neighbors, etc. Certain cameras may be allowable to share while others are not allowable, for example, cameras placed inside the home. A friend request/response may involve one or both of a request/response by a user having a user name, tag or phone number, email address etc. associated with a particular chat protocol or app, along with a wireless request/response procedure that associates or links information in the friend request. This way, once a friend request is shown, the friend request may coincide with a wireless transmission at a given power level that is heard by a transceiver at the receiver side. This way, it can be confirmed that 1) a friend is known and 2) a friend is actually nearby and/or has camera footage to share nearby. Relay devices may be used to relay the request response. For instance, if one home is located in a center of town and receives a video feed from a home on the east end of town which is not in communication with a home on the west end of town, the center home may act as a relay and thus may establish that the east and west end homes are correlated in terms of distance, by way of receiving and providing wireless signals at a particular power level or direction.

It may be that the system correlates video footage from one area or location having a given radius with another area or location of a given radius. This may enable tracking of vehicles and devices that are capable of traveling great distances.

Methods for security may be performed using video cameras and integrated sensing devices. For example, a method of US20240364846 may be modified as 1. A method of video summarization, comprising: transmitting a request for nearby image capture devices, wherein the image capture devices may or may not include integrated sensing devices, wherein the request is sent via unicast, broadcast or multicast, wherein the request is sent in a beam direction, altitude direction, proximity location, or among multiple directions/locations; receiving one or more responses, wherein the responses originate from one or more mobile devices or vehicles in the nearby area; receiving, at a video recorder, at least one image frame from each of the plurality of image capture devices; determining, by a processing circuit of the video recorder, whether to store each of the at least one image frame in a local image database of the video recorder, based on a data storage policy and/or based on a location of the mobile devices or vehicles, an image quality, a comparison between one or more image frames or groups of image/video frames, information on a MEC device; responsive to determining to store one or more of the at least one image frame in the local image database, storing, by the processing circuit, the one or more of the at least one image frame in the local image database; and transmitting, by the processing circuit using a communications interface of the video recorder, the at least one image frame to a remote image database or transmitting alarm information. 2. The method of claim 1, wherein each of the vehicles advertises a capability of providing video transmission, on demand, based on a certain location. 3. The method of claim 2, wherein each of the vehicles receives an indication of resources of periodic resources for transmission of information and a resource pool for emergency type transmissions, for instance, when the vehicles detect smoke, fire, burglary, an alarm condition, excessive traffic, accident, street level incident or other conditions. 4. The method of claim 2, wherein the vehicles receive operator preferences on sharing of video camera images, wherein one such preference is for emergency use only, wherein another such preference is any time requested, wherein another such preference is only while on public roadways. 5. The method of claim 4, wherein vehicles store information comprising video footage comprising previous footage, wherein the previous footage is associated with metadata including location, time, direction metadata and event metadata another other metadata herein. 6. The method of claim 5, wherein the vehicles process requests from user devices that request information according to metadata; wherein the vehicles provide responses to the requests based on access parameters, capability, timeliness of the requests, the meta data included there, wherein responses may include video footage information according to the requests. 7. The method of claim 6, wherein the system compares a likelihood of an event about to occur, based on information collected from various devices and triggers an alarm when the likelihood exceeds a threshold. 8. The method of claim 7, wherein if a video camera inside a vehicle is determined by a third party to be not up to a certain hardware or software specification, allowing a hardware or software upgrade to occur based on the third party request and a stored capability of the vehicle and/or camera or other device in the vehicle. 9. The method of claim 8, wherein a network node allocates a temporary resource grant in the uplink and/or downlink direction to allow communication from one or more sensors of a vehicle in range, wherein the size, periodicity and/or QoS of the grant is associated with information learned by the network node from information of the request or the response. 10. The method of claim 9, wherein communication between at least one vehicle is handled via a sidelink resource grant.

There may be one or multiple slices which have access to information of a camera, for example, as defined by Extensible Markup Language or other methods. Cameras, network slices, and microslices may report and receive capability information, for instance, via SIP options exchanges. Reporting of capability information may be based on collecting device details, including make/model no. and or may be based on other fingerprint information collected, e.g. signaling information, noise information, network access request types, parameter transmission scheduling, other capability requests or the like.

Slices and microslices may form an association with a mobile device, for instance, by receiving association information over the air via cellular, Wi-Fi or Bluetooth signaling from a virtualized access point or other wireless device which has been instantiated on a physical piece of hardware that may or may not be shared among other (micro) slices, the word microslice and slice may be used interchangeably herein.

Slices may perform SIP capability signaling and may receive SIP capability signaling from other slices and from remote devices and/or UEs.

UEs may report a capability to perform segmentation, a capability to retrieve information from a slice or the like.

UEs may report an interaction capability with a slice, for instance, UEs may report a capability to provide requests, wherein such requests are distributed upon one or more slices. Requests may comprise requests for information which may be associated with a camera, slice, time, location, or group thereof. For instance, UEs may provide a request for certain information, based on metadata. For instance, a UE user might want to know where a teenage child is located who has a car. The request may include an image of the car, an image of the inside of the car, information about the car, and such request information may be sent to the car, to cars which are discovered within range, to cars which have previously been in range (as seen by video), to homes and slices which have previously captured footage of the car.

A UE may associate contact information with slices. For instance, each user in a users contact list may be associated with a slice or group of slices and information about the slice or slices may be voluntarily shared among users who both have each other in a contact list. Assuming that each other is included in a contact list, there may be automatic sharing of certain slices or it may be that the user is allowed to request access to certain slices by way of being in the contact list. Users may report an ability to share slicing information via SIP or other capability options exchanges.

A request/response approach may be provided, for instance, a MEC Server or other server may handle a request for accessing certain slices or slice information, such a request may be processed via confirming, based on information of the slice and confirmation of allowability information of or on a UE, that access is allowable.

Alternatively or in combination, a user may offer sharing of MEC services and slices via a buddy list arrangement wherein buddies may advertise the availability of certain services and those may be requested on an individual basis.

A method performed by a computing device or set thereof, the method comprising: receiving images of a package being delivered; receiving images of an individual receiving the packages;
associating the individual with the package; receiving images of the individual and an object, wherein the object came in the package; associating the object, individual and package, in a data structure; performing a look up, based on the object, to determine advertising materials; determining, based on the object, the advertising materials and the individual, that the individual is likely to be interested in one or a plurality of objects; determining, based on the object, the advertising materials and the individual, that the individual is likely not interested in one or a plurality of objects; targeting ads to the users computer, tablet or phone, based on the users computer, tablet or phone being associated with an image capture device which took the images of the package being delivered and/or the images of an individual receiving the packages and/or the object, wherein the targeting includes delivering an advertisement, wherein the targeting includes no longer delivering advertisements of a category.

In embodiments, MEC systems may be used for location identification. For instance, if one object is detected, information associated with the object may be distributed at different compression levels. For instance, low level compressed information of the object may be first transmitted toward devices/slices located nearby, e.g. via a certain number of hops or via a distance determination scheme. For providing such information to further located elements, the information may be further compressed due to a likelihood of such information not being as relevant a time/location distance away.

Autonomous machine embodiments are provided herein. For example US Patent publication no. US20240370015 addresses the remote operation of a vehicle, but stops short of including network assistance abilities. 1. A method comprising: receiving a request for sensor data; estimating a latency or time delay associated with converting raw sensing data into one or more compressed formats; determining, based on the latency/time delay as compared to a threshold which is based on a requirement, QoS level, battery level, or other requirement herein, whether to convert the raw sensing data into one or more formats, wherein the one or more formats include a first low complexity format, a second medium complexity format and a third high complexity format, wherein the low complexity format takes less time to process than the medium complexity format and the medium complexity format takes less time to process than the high complexity format; sending, using an autonomous machine and to a remote system, sensor data obtained using one or more sensors of the autonomous machine as the autonomous machine operates in an environment, in raw format or in accordance with a complexity format; receiving, using the autonomous machine and from the remote system, data indicating a location in the environment for the autonomous vehicle to navigate toward, the data determined based at least on one or more waypoints that indicate the location in the environment; determining, based at least on the data indicating the location, one or more controls for navigating the autonomous machine toward the location; and causing, based at least on the one or more controls, the autonomous machine to navigate toward the location in the environment. The method further comprising receiving a resource grant that is sized according to a complexity format and formatting the raw data in accordance with that format with or without consideration of latency. The resource grant may be determined based on 1) a reported knowledge of the type of sensor, capability of the sensor and certain environmental parameters; 2) based on information determined via detection from unencrypted over the air signaling or other requests provided by a vehicle or MEC device; 3) autonomously.

In some embodiments, systems may learn camera poses, based on comparative information from multiple cameras (e.g. of multiple slices), by merging such camera information and deriving same footage captured across scenes. Camera pose may not be static, but in scenarios where cameras or ISAC systems are movable or are located on moving objects, pose may comprise an angle, velocity, acceleration, field of view (per the ability to move) etc.

Camera and sensor information may be exchanged over IMS/SIP servers as is shown in the example below. A 3d combiner server may act to combine video/images/audio/sensing date of multiple cameras (e.g. cameras a and b), and provide 3 dimensional data back to each camera or to another device, UE, MEC server, application server or the like. Any one or more of the capabilities disclosed herein may be reported in steps 1-6, among UEs, devices, servers etc. Additionally, in addition or instead of combining 3d video information, other information collected from one or more parties using devices herein may be combined and reported in a format according to capability information. If two devices do not support a capability, and one of the devices indicates an IMS based upgrade capability, the lower supporting device may be upgraded based on the capability exchange. Additionally, the application server may learn of the capability mismatch or may learn of low capabilities of either side or both sides and may upgrade each based on an ability to be upgraded. See 3GPP TS 23.228 V19.0.0 (2024-09) for applicability to augmented reality.

The following claim of WO2023034146 should be amended herein: A method performed by a base station, the method comprising: detecting interference based on the presence of an interferer, based on the transmission of an integrated sensing symbol included in a transmission, wherein the transmission is a downlink transmission, sidelink transmission of another device, or uplink transmission of a UE; determining the power spectral density (PSD) level from the interference; based on the PSD level exceeding a threshold, determining a synchronization signal burst (SSB) frequency location that mitigates the interference, modifying a periodicity of an SSB, employing a new, wider or narrower beam for the SSB and/or taking other mitigating actions; and transmitting a signal in the determined SSB frequency location to at least one UE being served by the base station or which has been temporarily served by another base station.

The below table illustrates example transmit patterns for a certain shifted ZC sequence of length 64.

TABLE 2
Transmit patterns for a certain shifted ZC sequence of length 64

| | |
|---|---|
| Shift: | Grant size |
| Even shifts: | Resource pool selection |
| Odd shifts: | Single resource element |
| Shifts divisible by 4 | Small transmission |
| Shifts divisible by 8 | Medium |
| Shifts divisible by 16 | Large |
| All others | periodic resource |
| | transmission |

Other allocations may be included and a size, position or usage of a corresponding time-frequency resource block, band/frequency or a selected pool from a plurality of pools may be utilized based on the selected shift. The shifts may still employ randomness in the divisible shifts. For instance, there are four shifts possible in the case of 64/16, (e.g. 16, 32, 48 and 64) The UE may randomly select one of these four to indicate a periodic resource transmitted, and, each of the four may ZC sequences may be uniquely associated with a different size transmission or may be each associated with a same transmit size.

In embodiments, the BS or other receiver may use AoA or ToA parameters of the ZC sequence to determine an angle, delay doppler parameter, or other parameter about a transmitter such that that transmitter may be said to be orthogonal to other transmitters operating on same time/frequency resources. This being, for instance, that even in the condition where two ZC preambles are received, it may be that the BS can ascertain that each transmitter is on such disparate beams that the transmitters can be used simultaneously and the BS may provide an indication to each transmitter to continue using same ZC determined resources. In some embodiments, the BS may blank certain ZC shifts as indicated in SSBs or other signal. This way, the UEs may need to not transmit on certain resources, at particular times in the uplink and can do so without the need for DCI signaling pertaining to such uplink transmissions (alternatively, DCI signaling for this purpose may also be included).

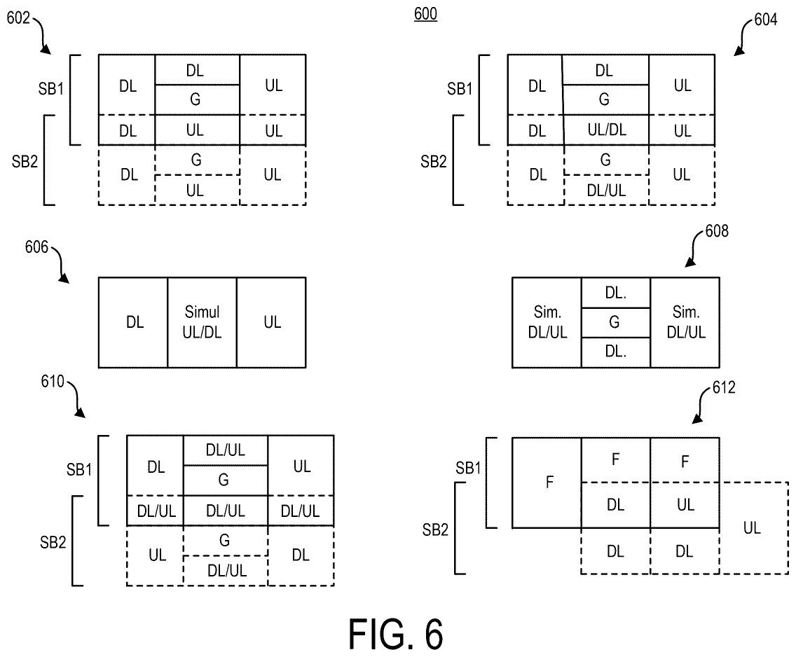

FIG. 6 demonstrates that subframes may be time aligned and partially overlapping. In the example shown in 602, a first subband and second subband may overlap partially, e.g. the lower frequency region of sub band 1 may overlap with the higher frequency region of sub band 2. Example 604 demonstrates a similar concept except that there may be flexibility in the UL/DL configuration of some slots or resources. Example 606 demonstrates DL, simultaneous UL/DL and UL. Example 608 shows simultaneous DL/UL, followed by DL with a guard band (DL/Guard/DL), and simultaneous DL/UL. Example 610 is a variant of example 604. Example 612 shows that transmission time intervals may be displayed over time and aligned to partially employ a shared frequency.

In the examples above, subframes may be time aligned and partially overlapping in the example at top left, bottom left and top right, for instance as transmitted by one or more transmitters to one or more receivers. At bottom right, subframes are partially overlapping in frequency and in time such that there is not full alignment in either time or frequency. There may or may not be a need for the guard bands as specified in the above examples. If they are not used, those shown may be dedicated to uplink or downlink and or a combination of the two. Each partial overlap may be handled by beamforming and AoA or ToA based methods at the UE side, BS side or in terms of sidelink. There may be simultaneous UL/DL at the base station side. Configurations of the overlapping portions may be made via RRC signaling indicating a flexible overlap scheduling availability, based on capability information of UEs/BSs. DCI may indicate direction of a subsequent symbol, slot, overlapping subframe portion, band, subband, etc. In each case where there is simultaneous UL/DL shown on same frequency resources, this may occur if and only if a threshold priority level is met for either the ul or dl and/or if there is a latency requirement to send or receive on such resource. This requirement may be based on a likelihood of transmission or reception of the dl or up when there is full duplex performed.

Integrated sensing procedures may or may not be performed in accordance with a probability of a detection, likelihood of an incorrect or false detection and an estimated accuracy of an object or other item detection. Parameters, e.g. KPI and KQI based parameters may be provided via RRC to a UE, such that the UE may make requests based on certain probabilities an estimates. For instance, RRC may provide parameters of one or more base station elements and one or more UE or other device elements that are each adapted to perform sensing/video imaging. The parameters may include a device type; stationary indication; resource utilization; probability of detection success according to an object type, size, location, speed, trajectory, angle, etc; integrated sensing or protocol supported; latency threshold; ISAC reference signal density available; etc.

A UE may periodically report its location, via IMS, and its capability to perform sensing in that location. The UE may periodically report an indication of visible object types in accordance with an angle, altitude, etc. The UE may report traffic conditions and may report whether it detects ISAC reference signals provided by other objects, for example, other wifi stations, other UEs, or base stations. Thus, a UE may report discovery information as to other potential devices which may be a transmitter/receiver of sensing signals. In this way, other UEs may use the UE as a sensing receiver to detect 3^{rd} party objects. Alternatively, or in combination, UEs may receive a DCI based resource grant for transmission or reception of sensing signals alone or in combination with a resource grant for transmitting sensing observations.

In an embodiment, a first IoT device may be a low power device and receives signals from a plurality of satellites and/or one or more access points in range. The first IoT device may transmit a backscatter signal based on the satellite signals when satellite signals from the two satellites overlap at the IoT device such that the strongest receive power is provided to the first IoT device. A second IoT device may receive power from one satellite of the two satellites and may receive the transmission from the first IoT device and may, based on that transmission and another transmission(s) may relay the transmission by the first IoT device to an access point which provides power to the second IoT device. A switch may relay the transmission to the core network. The core network may provide scheduling parameters to schedule a) the timing of transmissions of the satellites; b) the scheduling timing to/of the IoT devices; via a feeder gateway and one or more APs. The first IoT device may decide to use only transmission of satellite 1 or satellite 2 based on RSSI of either satellite. In embodiments, the relay IoT may listen on frequencies corresponding to satellite 1, satellite 2 and a combination of the pair to receive signaling from the first IoT device. Alternatively, or in combination, both IoT devices may transmit in parallel to the AP, based on joint signaling from the plurality of satellites. There may be techniques used in What will Private 6G be? By Onur Sahin which are applicable in this embodiment, for example, in the case where some of the disclosed elements are of a private network and some disclosed elements are of a public network. satellite 1 and satellite 2 may duplicate transmissions (in whole or in part) or may duplicate reference signals of transmissions, such that signals may be provided coded or received by IoT devices in a manner fit for backscattering. In embodiments, one or more of the satellites may be in sight of the feeder gateway, for instance to perform integrated sensing operations on the feeder gateway, e.g. to check for snow, ice conditions at the gateway to monitor its direction, angle orientation, rotation, etc.

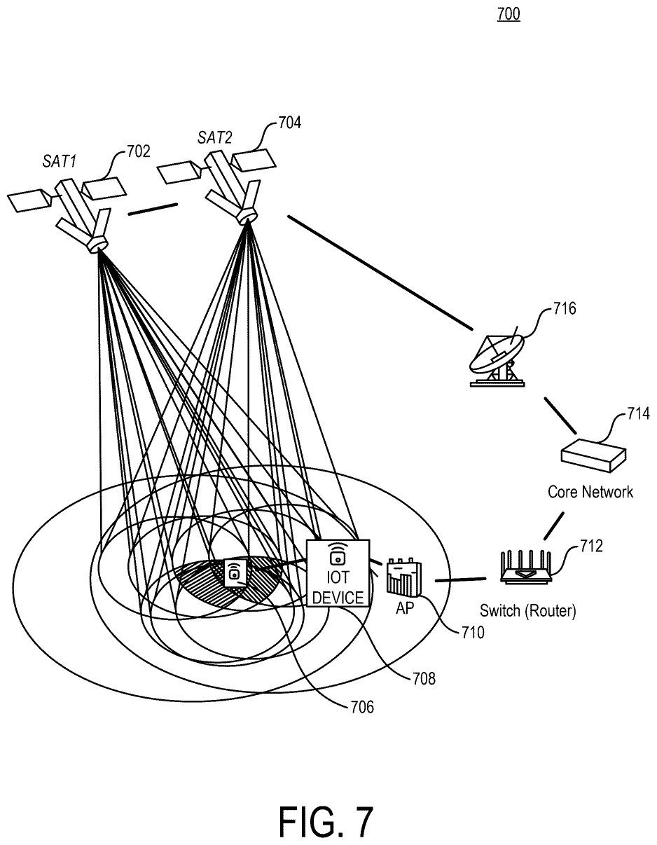

FIG. 7 is a diagram 700 showing IoT devices and an AP within NTN. For instance, two satellite nodes SAT1 702 and SAT2 704 may provide service over a partially overlapping service area. A first IoT device 706 may be within range of both satellites 702, 704 and a second IoT device 708 may be within range of SAT2 704. AP 710 may also be in range of one satellite, for example, SAT2 704. IoT device 706 may receive information from SAT1 702 and SAT2 704 and provide uplink to IoT device 708 which is in communication with AP 710. AP 710 may be in communication with switch 712, core network 714 and backhaul device 716. Data transmissions may flow back to SAT1 702 and SAT2 704 using such path.

Embodiments disclosed herein may entail a combination of injecting dummy packets or frame portions into an existing data session. For instance, the two satellites above may be transmitting data signals to other users simultaneously with signals provided to the IoT devices. Some Wi-Fi signaling embodiments are provided herein with which STAs may control APs and relay APs to provide signaling dedicated to backscattering communications and allocate reception resources for receivers of the backscatter. Based on a communication range between the powering devices, multiple devices may coordinate to perform targeted powering carrier wave transmission.

In embodiments, IoT devices, readers and ambient transmitters may transmit a mix of isac symbols, RSs, with backscatter charging frame transmissions. A beam utilized may provide a degree of trust. Devices may be capable of group simultaneous transmissions, based on triggering, so backscatter each others signals, possibly based on a sequence rs that is randomized. Xor'ed the sequence with the carrier and tx that among group size associated with the length of the rs. The rs may be sent in a dl.

A UE may enter a car, wherein the gNB is virtualized in/at car, other UEs connect to the gNB which performs its own SSB transmission, RACH messaging, etc. The gNB connects via an Xn interface to another gNB. The virtualized gNB may also instantiate a wifi access point such that the wifi access point allows connections to the gNB. Multiple gNBs may be instantiated at a single gNB, for example for operating on same or different frequencies, using different beam transmit periodicities and/or being associated with different kpi/kqis. Backscattering communication may be used to implement virtualized cellular functionality, for instance, the functionality described above as well as other limited distance communication interfaces in scenarios where devices are virtualized.

FIG. 2 of Kaveh recites “Devise a sequence of power levels, Configure the modulation pattern, Transmit the power sequence via RIS.” Such sequence of power levels may be derived based on power levels of another transmitted sequence. Alternatively, or in combination, a frequency/time may be configured also. For instance, a tag may be in range of a reader and another transmitter, e.g. a television/radio signal, a drone, a satellite, etc. at the same time. Both the reader and the other device may be configured to modulate a power level to provide signaling power and/or communication to the tag. In this way, the reader may be aware of the varied power level of the other device and/or a timing/beam of the other devices transmission. So, the reader may vary a signal in time/frequency/beam to align (alternate resources, use same resources to increase power, etc.) with the transmission of the other device. In this way, a tag can obtain power level sequence information from more than one device simultaneously. In embodiments, a gNB may preconfigure power level sequences to one or more devices for such purpose, over a core network.

By having multiple devices configure a voltage in profile, devices may need to be aware of (e.g. signaled with) a voltage out profile. So, for instance the following may be modified “Create a vout profile, Generate a unique ID, Backscatter a message via RIS, store vout and ID in memory.” May be modified to create an array based vout provile, generate an array based unique ID, backscatter a joint message or elongated message and store IDs in memory. The elongated message may be a sequence of power level/ID pairs, wherein the message may comprise a header portion indicating a length of the sequence. In this way, a tag may communicate.

The gNB may also be used to allocate time based resources for reader transmission and reader receptions via the RIS and directly between two or more devices or via a backscatter or other relay device; and communicate and control other carrier/power supplying devices, drones, satellites, etc.

In embodiments, a network slice dedicated to a home or group of homes to ensure isolation, bandwidth prioritization, and fair resource allocation. Security cameras, smart locks, and thermostats may be organized into microsegments. A camera detects a branded delivery box, the corresponding metadata is securely transmitted to an advertising application hosted at the MEC platform. The cameras, smart locks and thermostats have transceivers that operate in a backscatter manner. A transmitter transmits a sensing signal that overrides other signals of the transmitter or another transmitter. The group of homes is in range of a transmitter that transmits a synchronization signal block (SSB), wherein the SSB comprises sensing and data signals transmitted periodically in different directions, wherein each house receives a sensing signal at different times/beams. The cameras, smart locks and thermostats have transceivers that operate in a full duplex manner, wherein frames of the full duplex transmission are overlapping in time and frequency.

In embodiments, a UE may have the ability to discover certain capability information about another UE, via the IP Multimedia Subsystem (IMS) or another cellular specific protocol. The capability information may be related to a list of applications (for instance, messaging applications, payment applications or the like) with which a peer UE supports.

A capability exchange may further relate to certain information and capabilities of each application of a UE. The capability exchange may be performed based on a user handle, email address, phone number or a randomly generated identifier which is associated with a peer UE.

For instance, if a UE is capable of WhatsApp, it may be that a message originator may decipher such information in advance of having to download WhatsApp. The IMS may organize and list applications according to their functionalities, e.g. WhatsApp is a type of: messaging application, video application, audio calling application etc. Another application, for instance, Paypal, is a type of payment application. An IMS server may organize types of applications, and associate types of applications with privacy level information, such that a UE may control who is able to decipher which applications are supported and which are not. Similarly, a UE may be capable of and registered for WhatsApp, Telegram, Messenger and WeChat via IMS.

In embodiments, when a user subscribes to an application, e.g. a messaging service, the APP store (e.g. Apple store), App developer, the App itself, the downloaded phone, etc. may report, via SIP/IMS procedures, that the UE has been upgraded with a third party app capability. On the reverse, as UEs are upgraded or changed, capabilities may change and thus, a UE may report the loss of a certain capability/application.

A method performed by a UE may comprise: transmitting a request, via SIP and IMS, requesting a list of applications supported by a recipient or recipient(s), wherein the request includes one or more of a phone number, handle, or user name; receiving a response, via SIP and IMS, indicating the list of applications, wherein the response indicates a user name, handle, phone number associated with each one of the applications; wherein before the response is provided, a message is sent to a phone associated with the phone number, requesting permission to provide the response.

A method may comprise receiving information as to whether a UE is reachable via satellite, drone or UAV and providing such indication as capability information, wherein message routing may or may not be performed exclusively via satellite, drone or UAV or in combination with a terrestrial base station.

A method for reducing latency in the establishment of an IMS related session, the method comprising: transmitting, by a sending vehicle, a SIP options message having a broadcast or multicast based user address, relevant location information and information about a sender of the SIP options message, wherein the information about the sender includes a secure identifier generated and provided via a cellular network; receiving, by one or more receiving vehicles within the location, the broadcast or multicast based SIP options message, and comparing secure identifier to an identifier resident on the receiver, for example, via a request/response procedure performed via a network; assuming the secure identifier verifies the authenticity of the sending vehicle: receiving, by the sending vehicle, capabilities of each one of a plurality of users/vehicles within or near the location; establishing, by the sending vehicle, an application specific session with one or more of the plurality of users/vehicles, based on capability information received, wherein the capability information receives includes one or more application identifiers and one or more capabilities or user handles associated with the one or more application identifiers; wherein the broadcast or multicast based user address may be determined via lower layer signaling and/or based on a sidelink signaling procedure; wherein the sending vehicle registers vision capabilities including 2d, 3d capabilities, filtering capabilities, IMU capabilities and stereo vision capabilities.

A method for reducing latency in the establishment of an application specific connection between an originating party and a responding party, the method comprising: sending, by the originating party, a SIP OPTIONS message identifying information about a responding party and a type of applications that are requested and information about the type of applications, wherein the type of applications requested include payment, gaming, utilities, education, social media, productivity, weather; wherein the information about the type of applications includes whether the applications support voice, video, haptic feedback, latency properties, security properties, etc. receiving a response, by the originating party, via IMS; determining, by the originating party, which one of the applications support an application need and a type of need, based on the response; and establishing an application specific connection with the responding party, based on the determination.

A method may comprise: retrieving, by a first UE, from a server located in an IMS, in a cellular network, on a network edge (e.g. at a BS or satellite) or outside of a cellular network, information about a second UE, wherein the information comprises a user handle of an instant messaging application or metaverse, wherein the handle is not a SIP URI; sending the handle and an id representing the messaging application, by the first UE, to an IMS gateway, via a SIP protocol message; determining, by the IMS gateway that the handle corresponds to a SIP URI; returning, to the first UE, based on the SIP URI and privacy level information associated with the SIP URI, the SIP URI, a randomly generated identifier that maps to a SIP URI of the second UE or no SIP URI at all; on a condition the SIP URI or randomly generated identifier corresponding to it is received by the first UE, sending a SIP invite, to the a CSCF of an IMS network, the SIP invite identifying or including the SIP URI; forwarding, by the IMS network, the SIP Invite to an application server; determining by the application server, from the user handle, SIP URI, instant messaging application and any other relevant parameters, that another application server is needed for communication between the first UE and the second UE; instantiating the another application server; forwarding the SIP invite to the second UE, based on the SIP URI or the randomly generated identifier, wherein if the randomly generated identifier is used, the first UE is unaware of the SIP URI of the second UE; establishing a communication session between the first UE, the two application servers, and the second UE, wherein one of the two application servers is managed by a network operator and one of the application servers is managed by an operator of the instant messaging service.

The method of any claim herein, wherein an application server of a third party is established in an IMS network.

An IMS network, wherein the network instantiates one or more application servers, based on contents of a received SIP Invite, wherein the application servers include one or more of an IoT Application server, Real-Time Sensor Application server, ISAC Application Server, Autonomous vehicle Application server, Energy efficiency Application server, 3D maps of environments Application server, Traffic Optimization Application server, Energy Grid Management Application server, Environmental Monitoring Application server, Advanced Telemedicine Application server, Remote Surgery Application server, Real-Time Patient Monitoring Application server, Latency Reduction Application server, AI network routing Application server, Security and privacy Application server, Haptic feedback Application Server, Distributed Ledger Technology/Blockchain Application server, High Frequency communication Application server (e.g. millimeter wave and terahertz wave), Reflecting and steering Application server, Smart Devices and Gadget-free communication Application server, VPN application server, metaverse application server, AI generated emoji/sticker application server, chatbot application server.

The IMS network, wherein a plurality of application servers are selected, based on an identification of a user agent in the SIP invite or based on an application initiating the SIP Invite, wherein the IMS network identifies and selects the required application server(s) automatically without express signaling indicating the AS, from an initiating UE.

A system comprising a UE, base station, IMS, and a plurality of application servers, wherein the UE sends a SIP invite to the IMS; the IMS extracts, from the SIP invite, relevant parameters for determining a plurality of application servers; the IMS sends the SIP invite to the plurality of application servers and receives responses from each application server of the plurality of application servers, wherein the SIP invite is sent to each application server along with parameters determined via the IMS from other information sources of a core network; wherein the other information sources provide parameters, to the IMS, including: application server (AS) availability, AS latency, mapping between entities described herein, a time which a particular AS needs to be available by, information regarding which AS(s) have CPU utilization or energy utilization above a threshold or below a threshold, antenna configurations, AI/ML configurations, measuring and reporting capability/threshold/timing, CSI information, air interface parameters, or the like; the IMS sends the SIP invite or other SIP/IMS messages, to other devices (including UEs, base stations, other IMS servers, AS(s) etc), based on or in accordance with the discovered parameters.

A method may be performed by an IMS or server thereof, the method comprising: establishing a SIP session, based on latency requirements of a SIP invite, wherein one or more application servers are not instantiated immediately before the session is end to end established; determining, based on message contents of the SIP session, that one or more AS(s) should be added once the call is in session, depending on an AS availability, AS energy usage threshold, number of ASs added to a session, information about one or more parties to the SIP session, and the like; adding the one or more ASs to the SIP session, on a condition that the ASs is/are available to the parties, wherein the added one or more ASs are added, depending on a need of one or both peers, wherein, in embodiments: a first AS is added at or near a base station of a first peer of a plurality of peers; a second AS is added at or near another base station of a second peer of the plurality of peers; wherein a third AS is added based on the addition of a third peer of the plurality of peers; wherein each AS modifies a component of or performs a function of the SIP session based on the needs of a particular peer; wherein at least one AS is removed from the SIP session before the session is town down, i.e. the session continues for some period of time during which the peers operate with limited AS assistance.

A method performed by a IMS server, wherein the IMS server ignores a capability of a receiving UE, e.g. capabilities identified in a SIP OPTIONS message, the method comprising: receiving, at a first UE, capability information of a second UE, wherein the second UE has deficient capabilities to perform a function required by a SIP session initiated by the first UE; sending a SIP invite, by the first UE, to an IMS server, wherein the SIP invite is for a session for which the second UE is incapable of participating in, based on its current capabilities; instantiating a conversion function AS, based on the protocol desired by the first UE and a lacking protocol of the second UE; forwarding, by the IMS server or other server, a modified sip invite to the receiving UE, wherein the modified SIP invite is for a protocol which the receiving UE does support; establishing a SIP session between the first UE and the receiving UE, wherein the conversion function AS converts a protocol supported by the first UE into a protocol supported by the second UE and vice versa.

A UE may: transmit a register request to a server (IMS server, message gateway, application server, etc.) that indicates support for rich communication services (RCS) over non terrestrial networks (NTN); receive, in response to the register request, an indication that the UE is registered for RCS in NTN, wherein an RCS application server supporting one or more of: voice, video, standalone messaging, chat, group chat, file transfer, geolocation via RCS, chatbot communications or payment via RCS [all via NTN]; wherein the register request indicates support for IMS based polling, wherein a database is stored in an application server for recording polling responses.

An embodiment disclosed herein, wherein one or more methods herein support a reduced SIP header group, wherein the reduced header group includes one or more SIP header fields with reduced bitlengths compared to a standardized bitlength and/or a reduced set of information elements within the SIP message.

A method performed by a UE may comprise: indicating, by the UE, support for TN to NTN session continuity and for NTN to TN session continuity; receiving, by the UE, a peer capability to support TN to NTN session continuity and for NTN to TN session continuity; based on one or more of the TN to NTN and NTN to TN capabilities of one or both UEs, sending a SIP invite; establishing a session via one of TN or NTN; indicating, to the IMS, that handover is in process; indicating, by the IMS, to one or more application servers that the handover is in progress and indicating an expected time for the one or more application servers to refrain from performing certain actions, wherein the IMS and/or the one or more application servers insert null or otherwise non-UE generated packets during the handover process for a period; indicating, by the UE to the IMS, that handover is completed and indicating by the IMS to the ASs that handover is complete.

A nameserver operating in a IMS network, the nameserver having a: Receiver configured to receive a SIP URI from a UE or other device; Database configured to translate between SIP URI and instant message handle(s); Transmitter configured to return the instant message handles to the UE or other device. A nameserver operating in a IMS network, the nameserver having a: receiver configured to receive the instant message handles from a UE or other device. database configured to translate between SIP URI and instant message handle(s), wherein the database is updated on receipt of the IM handle(s) by checking whether handles are active or not; transmitter configured to transmit a SIP URI to the UE or other device.

A method performed by one or more of an IMS, server, MEC, UE, the method comprising: estimating one or more of a: Total number of users; Number of users in slice s; Set of services offered; UE slice; User j from slice s; Task generated by UE j; Number of bytes from task Tj; Number of CPU cycles from task Tj; Acceptable latency for task Tj; Distance between UE j and RU; Total number of communication RBs; Total number of computational resources; Channel capacity between UE j and RU; Number of communication RB allocated to UE j; Number of computation resources allocated to UE j; Bandwidth of each communication RB; Transmission power of UE j; Processing power when the task is processed locally; Idle power when the task is processed on MEC; Path loss exponent; Transmission delay of task Tj; CPU frequency of UE in slice s; CPU frequency of each computational resources; Processing time of task Tj locally; Processing time of task Tj on MEC; Energy consumption for processing the task Tj locally; Energy consumption for processing the task Tj on MEC; Discount factor; Weights associated with each term in the reward function; Time of executing task Tj; Energy consumption of task Tj per [Ebrahimi]; based on the estimate, performing at least one method step herein and/or instantiating or initiation communication of at least one device herein, wherein the method step includes one or more of: sending at least one SIP message via the IMS; performing an ISAC procedure; instantiating an IMS virtually, based on an a threshold overload condition; initiating a digital twin of the IMS or to mimic another component or scenario; prioritizing real time traffic over non real time traffic or vice versa; upgrading the IMS, server, MEC or UE, via IMS or other protocols.

A method performed by an IMS server or other server, the method comprising: collecting predicted data, at a first server; standardizing the data; comparing the data to a threshold condition and on a condition the threshold is reached, transmitting a SIP Invite message to an IMS; receiving, via the IMS, the SIP Invite message and, based on the data or type of data, instantiating a digital twin application function and then relaying the data and newly predicted data to the digital twin application function, wherein the data and new data is relayed via the IMS.

A method performed by an application server in an IMS environment, wherein the AS sets up resources for communication over land, air and sea communication resources, including one or more of: medical device resources, remote surgery communication resources, hollographic connectivity communications resources, haptic communication resources, robot to robot or robot to everything resources, smart city resources, drone resources, factory resources.

A method performed by an IMS server in combination with a UE may comprise: receiving a SIP invite message from a UE and, based on the SIP Invite, assigning a session identifier to one or more application servers; transmitting a message to each one of the application servers indicating the session identifier, and an identifier (group identifier or plurality of individual identifiers) corresponding to the other ASs in the group; providing one or more security and authorization parameters for use by the ASs in communication with one another, wherein the AS(s) communicate with one another based on a consumer/producer paradigm, wherein: a POST message identifies the session and the AS(s), an OK response to a POST comprises information of the responding AS, wherein a DELETE message comprising a session ID may be sent to the group of AS(s), based on a group identifier in order to tear down the IMS Session, wherein PUT and PATCH messages to the group notify the group of additional AS(s) that are requested to join a session; wherein the IMS server assigns a group ID and manages the group of AS(s) and the session; wherein the group id does or does not change when an AS is released or added.

A method herein wherein RRC provides information about an available AS near a transmission/reception point (TRP), wherein the RRC is transmitted in SIB via the TRP.

An IMS that implements a decentralized peer to peer (P2P) network, wherein the IMS: receives a registration request and/or a SIP invite, by an resource underutilized by a threshold and having an energy criteria over a threshold, wherein the underutilized resource include a set top box, smart home gadget, dormant server, desktop or laptop computer or parts thereof, e.g. a video card, cpu, hard disk drive, etc.;

accepting or rejecting a registration request or a SIP invite, based on a resource requirement; wherein the IMS implements a content delivery network and only implements a portion of a p2p distribution network, wherein the IMS and/or an AS provides storage for video content or other content; wherein the IMS serves as a fall back option when a deliverability threshold of the P2P distribution network falls below a threshold; wherein the IMS implements one or more trackers that track the P2P peer server status, content location, traffic, demand and service requirements; wherein the IMS provides registered devices with information pertaining to connections to multiple peer servers that serve requested video and other data content, wherein the registered devices interact with the IMS via one or more SIP messages, by providing references to the data content in a sip message including but not limited to INVITE, ACK, BYE, CANCEL, REGISTER, OPTIONS, PRACK, SUBSCRIBE, NOTIFY, PUBLISH, INFO, REFER, MESSAGE, UPDATE and receives responses including 1xx, 2xx, 3xx, 4xx, 5xx and 6xx responses; wherein the CDNs are located inside of a cellular network, wherein the peers and content of the P2P distribution network are located outside of the IMS, preferably outside of the core network, preferably but not necessarily outside of the MEC, and preferably within terminal devices; wherein the CDNs inside the IMS or cellular network employ a DNS that operates and returns information according to privacy level information stored at an application server; wherein each peer is both a server and provider of content; wherein the IMS services search queries from users, via SIP signalling messages, wherein the IMS employs the P2P network for searching and is aware of contextual information for handling the searching; wherein peers report to the IMS their storage capacity, energy status and network latency/bandwidth availability; wherein the IMS includes a server that handles network address translation (NAT), based on reported capability and network information associated with a peer client or a requesting/searching client. [See Wei].

A system comprising: a UE having a cellular service agreement; a secondary device associated with the UE, e.g. a set top box, wherein the UE and the set top box operate an application provided by a same application publisher, wherein the set top box receives the application based on an association with the UE, from the UE, from a cloud server or from a P2P network; an IMS based data center that maintains a tracker cluster; a decentralized set of peer servers which are tracked by the tracker, wherein a subset of the decentralized set provide SIP invite messages to the IMS, wherein a subset that do not provide SIP invite messages to the IMS are discovered, via the IMS, by way of communicating with the subset of peers that do provide SIP messages, wherein those peers provide information about the peers who do not provide SIP messaging to the IMS, wherein the IMS becomes aware of other peers and receives tracking information via IMSs located on other cellular networks via an IMS to IMS protocol; wherein the IMS provides peers with first portions of video segments, and while those first portions are being displayed, the peers are able to request remaining segments from the P2P network, based on the IMS providing such information. [See Wei, reproduced by reference herein in its entirety].

A method for reducing initial video loading time, performed by a UE, the method comprising: transmitting a request for a video, to a satellite station; receiving a response, based on an estimated distance from the satellite station to the UE and capabilities of the UE, that provides some portions of the video and/or indications of peer clients that are discriminated by network type, e.g. terrestrial network type, such that the UE may being playback and request future video portions via the terrestrial network, wherein the UE provides a retrieval status of the terrestrial network to the non terrestrial network via the satellite link and an IMS.

A method performed by an IMS, comprising: receiving a SIP invite for establishing a connection between a UE and a server or device having a gateway to a peer to peer network; receiving requests for information, via SIP protocols and/or publish subscribe protocols, wherein the gateway translate the SIP protocols and/or pub/sub protocols into peer to peer requests by way of a tracker operating on the IMS or on an AS in communication therewith, wherein the IMS serves video information to the UE; wherein the IMS receives information corresponding to a scroll rate, e.g. the rate at which a user scrolls through video information comprising different short videos (e.g. <60 second videos), wherein based on the scroll rate, the IMS prefetches a first video segment of a next video for display to the user; wherein the IMS sends the first video segment and location information for retrieving a second video segment of the next video for display.

A method for compressing SIP and other messages sent via an IMS, the method comprising: determining whether it is acceptable to compress SIP messages by aggregating messages, wherein the determining is based on the method of accessing SIP via a plurality of SIP UEs, wherein the method of accessing is via IMS and via one or more of a satellite network, terrestrial network, drone or other UAV or via wired methods; on a condition that it is unacceptable to aggregate SIP messages, based on a latency requirement of an application, determining that pre-trained compression scheme is to be used, wherein the pre-trained compression scheme relies on previous SIP messages to establish a dictionary, wherein based on the pre-trained compression scheme a portion of SIP messages are cached on an edge node or nodes, wherein the dictionary may be retrieved by devices in communication with the IMS, wherein the dictionary is unique to the IMS.

A method herein, wherein the IMS is implemented in an underutilized device and/or wherein the IMS implements a P2P client which provides and retrieves information from a P2P network on behalf of an IMS registered UE, wherein a client transmits a SIP REGISTER request or a SIP invite to an IMS via Bluetooth, wifi or other wireless protocol.

A method for reducing addiction in video scrolling, wherein a users life is not wasted scrolling mindless videos, by the IMS receiving a SIP invite and periodically inserting information into a video stream indicating the amount of the users life that has been wasted mindlessly scrolling (since reception of the SIP invite or since establishment of the user session).

An IMS may implement an uplink or downlink buffer, on behalf of a UE subscribed to the IMS via a satellite or other communication link, wherein the IMS and UE negotiate, via request response messages, wherein the request and or response messages include a buffer size of the uplink or downlink buffer allocated, wherein the IMS implements network function virtualization.

An IMS server that: receives first application data from a second application server; receives second application data from a second application server; wherein the IMS server merges the first application data and the second application data, wherein the IMS server supports a session of a UE, wherein the first and second application data include one or more of haptic feedback data, voice data, audio data, video data, scene description format data and/or network control information; wherein the UE receives and/or operates based on the merged data; wherein the UE transmits a REGISTER message indicating support for motion-to-render-to-photon (M2R2P).

The method of any claim herein, wherein one SIM is a dedicated satellite SIM and another SIM is a TN SIM, wherein both SIMS are registered with a same IMS at the same time, wherein logical flows are discriminated by the UE on each SIM of the two or more SIMs, wherein low latency traffic is provided over the satellite connection and high latency traffic is provided over the TN.

A method performed by a UE comprising: receiving assistance information associated with an IMS registration procedure, the assistance data indicating one or more IMSs to perform registration with, wherein the assistance information associated one or more application services with a particular IMS of the IMSs, wherein the IMSs are virtualized; sending, prior to receiving the assistance data, a request to perform a search for candidate IMSs with a capability to perform one or more selected application services; sending a SIP invite, via one of the IMSs, based on a load condition of the one or more IMSs determined at the UE, wherein the load condition indicates a load on one or more ASs, wherein the particular IMS transfers an established session involving the UE and one of the ASs, to another IMS, wherein the another IMS is instantiated on demand or is determined to be operating below a threshold condition; wherein load is sampled, by an IMS network element, at a reference time determined based on a sliding window of time corresponding to a transmission by at least one UE.

A method of comprising: performing, jointly by a plurality of client devices, a registration procedure with an IMS network for handling high performance sessions, based on one or more feature tags included in a session initiation protocol (SIP) REGISTER request, wherein the plurality of client devices exchange feature tags before a single SIP RESISTER request is sent to the IMS; receiving, by a lead member of the plurality, a response to the SIP REGISTER request; based, by the lead member, that the SIP REGISTER response includes one or more of a: flexible workflows feature tag; neural network training feature tag; holographic type communication feature tag; holographic telesurgery feature tag and/or virtual orchestra feature tag; determining, by the lead member, that the network provides a provision for handling of immersive media streams; providing information about the registration to the plurality of client devices, either directly from the IMS or via the lead; sending, by a first client device, an SIP INVITE request; associating by the IMS, a feature tag included in the SIP INVITE with the first client device and forwarding that SIP INVITE to another IMS in a network of a second client device, wherein the second client device is not of the plurality of client devices; establishing, by the first client device, holographic type communication session with the second client device, wherein the holographic type communication session is jointly supported, via split processing, by the first client device and one or more of the plurality of client devices; and wherein the split processing is split based on a stream component, wherein two different devices perform processing of two different streams; wherein the split occurs among different devices that are connected to different RANS, e.g. satellite, NT, or other; wherein the split splits UDP vs TCP protocols; wherein registration may be performed separately for UDP as opposed to TCP as opposed to SCTP protocols; wherein QUIC stream IDs are split processed.

A method a (UE) having a first SIM and a second SIM, the method comprising: transmitting, by the first SIM of the UE, a SIP Invite, to an application server; receiving, in response to the SIP invite, information indicating that the UE is to employ the second SIM to perform discovery of one or more other UEs, wherein the discovery is performed using a shared antenna and chipset used to send the SIP Invite, wherein the response includes one or more media tags; identifying, via the second SIM, that two devices have the media tags and associating with those two devices via the second SIM; transmitting, to an IMS, a SIP message including the two devices and the associated media tags; establishing a communication session, via the IMS, wherein the communication session involves, on the UE side, the UE and the other two UEs, wherein all three UEs provide collaborative information via the IMS, wherein the media tags include XR related media tags, wherein the three UEs collaborate to provide AR information, haptic information and sound information via the communication session; wherein the three UEs implement same or different quality of service flows; wherein the AR information, haptic information and sound information is each provided by a different UE that compresses such information according to a compression scheme indicated by the IMS; wherein if the IMS receives any one of the AR information, haptic information and sound information incorrectly, estimating, at the IMS appropriate AR information, haptic information and sound information based on other AR information, haptic information and sound information; estimating AR information based on the sound information; estimating sound information based on the haptic information; estimating sound information based on the AR information; estimating haptic information based on the sound information and the AR information.

A method may comprise: obtaining data indicative of a first resource load and a resource availability as part of a first network slice having an IMS of a plurality of network slices of a communication network having IMSs; analyzing the data to determine that at least some communication sessions handled by the IMS should be reallocated to one of the plurality of network slices based on the load of each one of the plurality of network slices; reallocating a portion of a communication session, but not the entire communication session, to another network slice; wherein the portion reallocated is associated with a certain AS; and wherein a portion not reallocated is associated with another certain AS; wherein the reallocating is performed, in part, based on new SIP Invites received from other UEs, via one or more of the IMSs.

A method comprising: transmitting a SIP REGISTER message indicating a plurality of wake up capabilities of a UE; wherein the UE receives wake up capabilities of another UE, via the IMS, subsequent to sending the SIP REGISTER message; transmitting a SIP INVITE message at a wake time, based on the capabilities of the UE and the capabilities of the another UE, wherein the UEs: operate on different wake time durations; operate at different wake time periods; wherein the UE and the another UE communicate over the IMS at a same time; wherein at least one of the UEs is scheduled to wake in accordance with a satellite positioning at a given time; wherein the another UE is a stationary UE.

A method performed by a satellite station, the method comprising: receiving, by the satellite station, an RRC connection request from a satellite UE; determining, by the satellite station, that the RRC connection request indicates an establishment cause corresponding to a media tag; and communicating with at least one IMS, by the satellite station, the media tag; establishing a bearer at the satellite station and a bearer at a ground station to support the media tag; wherein the IMS receives information from the UE via the ground station and the satellite station, wherein the media tag is associated with both low and high latency data, wherein the low and high latency data are routed over one of the satellite station or the ground station or both.

An IMS comprising: a private metaverse; receiving a SIP INVITE, by a UE, requesting to join a private group; determining, based on privacy level information of the private metaverse, whether a reject message should be sent in response to the SIP INVITE; wherein the private metaverse comprises an extended reality environment; wherein the private metaverse operates within a public metaverse.

A UE that sends a SIP INVITE to request access to a private group; and An IMS that determines, based on forwarding the SIP invite to another UE, whether a reject message should be sent in response to the SIP INVITE, based on whether the another UE provided a reject message in response to the SIP INVITE. A method comprising: receiving, by an IMS server of a sixth generation (6G) telecommunications network, a SIP message from a UE providing capability information, requesting a communication session or requesting an amendment to an established communication session; identifying, by the server, a device identifier associated with the message; receiving, by the server and based at least in part on the device identifier, historical data associated with the UE from a core network element, MEC or an application server, the historical data identifying activity by the UE over a previous time period;
determining a RAN type and location of the UE; determining, based on the historical data, RAN type and the location, a set of application servers and functions to instantiate, for the communication session; and causing the UE to access required services for the established communication session, wherein access elements of the communication session are established prior to sending a SIP invite to one or more parties involved in the communication session.

An IMS server comprising: circuitry configured to receive a SIP message, from a UE, indicating a capability of a UE to control an avatar of another user; performing a look up function, based on the SIP message, to determine a SIP user agent to send a request; transmitting the request, to another UE associated with the avatar, based on the look up function; transmitting an identifier associated with the avatar, to the UE, wherein the UE is granted access to the avatar; wherein the IMS tracks gameplay of the avatar to the UE and not to the another UE; determining, based on information from the another UE, that the another wants to regain control of the avatar, wherein the information is a time period.

A method for IMS based remote control of a device, the method comprising: receiving a SIP message, from a UE, including identification information of a plurality of devices having locations; determining a that the UE has proper access to control one or more of the plurality of devices, wherein control is granted to the plurality of devices based on their location and based on access restrictions of the UE and the plurality of devices. Establishing a communication session between the UE and one or more of the plurality of devices based on the access restrictions, wherein access restrictions further comprise a number of simultaneously controlled devices, RAN parameters of the UE, latency and QoS establishments at the UE side, whether the UE has movement access or only read only access, access to a camera microphone or speaker, access to perform movement of an antenna or receiver or writer, etc. trusted and untrusted applications to subscribe to and receive reports-events related to IMS Data Channel services that a Network Function/Application Function can subscribe to IMS data channel initiation, update and release. This includes the initiation, update and release of application and bootstrap data channels.

Existing bootstrap data channel to download an application. A mechanism may be defined for how the terminating IMS network can support the called party to verify third-party specific identities used in a session.

In embodiments, standalone IMS bootstrap and application data channel sessions may be supported without accompanying audio/video/messaging media in an IMS session. The establishment of an IMS data channel session may be a fast establishment protocol to establish a minimum required service and then a UE may establish a full protocol to support additional services.

The termination of a (standalone) IMS data channel session(s) may be performed such that one or more sessions are torn down, but a single session is left open for fast reestablishment purposes.

A data channel application server that generates a group id corresponding to a group of served IMS subscribers, wherein generating the group ID may be based on: SIP IDs of (un)registered devices that are associated with a single UE; SIP IDs of (un)registered devices or a group of UEs (of same or different users); One or more avatars corresponding to the devices; RAN characteristics of the access technologies employed by the UE; Latency, QoS, compression support, profile(s), media tag(s); Registration threshold period, e.g. a group of UEs that registered during a fixed or sliding period of time; UE capability; required application servers to serve the UE;
SIP URI domain; separation of registered vs. unregistered devices; separation of trusted vs untrusted devices; separation of devices to trusted vs untrusted ASs; whether or not a UE is on another IMS, different network slice, or different IMS.

An NF and/or AF that does or does not subscribe any one or more of the following events: any of the messages which include information element and objects described herein SIP messaging events but not limited to INVITE, ACK, BYE, CANCEL, REGISTER, OPTIONS, PRACK, SUBSCRIBE, NOTIFY, PUBLISH, INFO, REFER, MESSAGE, UPDATE and responses including 1xx, 2xx, 3xx, 4xx, 5xx and 6xx responses successes and failures of association via privacy level information group identifier establishment group join, removal and reconfiguration events information regarding session (re) establishment events network joint processing and configuration status events including initiation events which result in success or failure reported local or network side rendering events network congestion and packet loss rate threshold exceeding events, (reduced) power level events XR scalability, reliability and optimization events Reporting conditions of live events, video streaming events, pose events, resolution change events SIM switch events, e.g. a sim becomes better than a threshold, but DC maintains Attack events including denial of service events Security events; bootstrap failure to establish notifications.

A system comprising: an NRF that discovers an IMS AS a DCSF that supports event subscription and exposure with IMS AS and/or NEF wherein the NF service consumer provides the NRF group information of a UE wherein the DCSF may be selected based on: UE group association, traffic type, application type, group size, number of UEs participating in a session, location of the DCSF in the network, the network slice of the DCSF, any/all of the parameters disclosed herein.

A system may comprise a UE which supports one or more of the applications described herein and another UE which fails to support one of the applications described herein, wherein data channel media is transformed between the capable UE and the uncapable UE by removing feature components in a media stream, including features related to vision, audio haptic or touch feedback, smell and/or taste; wherein based on the removal, an AIML algorithm is used to learn how to place one or more media type back in, based on other media types as were previously associated with those removed,
wherein a UE registers a mulsemedia media tag stipulating support for one or more of vision, audio haptic or touch feedback, smell and/or taste capabilities.

A UE that sends a registration message which includes capabilities of the users equipment, but also, registers an activity that the user is currently performing, for instance, a watch may transmit a SIP messaging indicating that the user is running, walking, has an oxygen parameter above a threshold, playing baseball, talking, etc, such that the IMS may associate a user in a certain state along with such capabilities. This way, the IMS may determine whether the receiver is capable of accepting a certain incoming invite message.

An IMS may flatten mulsemedia to video, audio, etc. based on the capabilities of the receiver and not necessarily just the inherent capabilities, e.g. screen size, processor speed, etc, but based on other simultaneous conditions of the receiver and its network. For instance, a UE may register with capabilities of performing mulsemedia, but given its registration is performed via satellite, the latency may be too high, and thus the IMS may flatten media aspects or remove them altogether simply due to experienced latency, QoS, information received from the RAN, information about a RAN received from the UE, etc.

IMS may add mulsemedia registered devices to a session, based on their capabilities and based on a capability of the network to flatten media assuming such devices do not have appropriate capabilities.

IMS data channels may use a keepalive that is consistent with a RAN node, and may add other services/devices within a time period associated with the keepalive.

An IMS may may receive a pointer or identifier associated with an avatar, in a SIP invite, so as to present the avatar to a called party. The IMS may perform certain filtering procedures to ensure that the avatar is appropriate and consistent with the capabilities and other information of the called party, e.g. age appropriate, etc. An avatar identifier may be as followed and may incorporate information including a integer, string, UUID, or a URI (URN or URL). An avatar or group of avatars may be associated with a group ID. Certain users of the group may have access to avatar for a set period.

A user may configure an avatar, by way of a provider, and then configure the IMS with a plurality of avatars, each one or more avatars from a different service provider. In embodiments, the IMS may or may not share avatars with certain users, based on a privacy level feature embedded according to provider. So, for example, if facebook avatars are desired to be kept secret from non facebook users, the IMS may ping the facebook AS with an avatar ID to perform the checking. Similarly, for another provider, the IMS may or may not provide avatar information to a UE or other device according to the privacy level information associated with that provider. The IMS may or may not share other avatars of a same user of another provider based on a users configured privacy level(s).

An avatar information element may comprise a list of providers and a list of avatar identifiers according to each providers listed. A length or number of providers/number of ID elements may be included as subelements. Avatar provider x and y may use different style identifiers and this may still be consistent with the IE below.

TABLE 3
Avatar IE

| | | | | | | | | |
|---|---|---|---|---|---|---|---|---|
| Length/ | Avatar | Avatar | Identifier | Relationship | Avatar | Avatar | Identifier | Relationship |
| number | provider | ID1, | for | between | provider | ID1, | for | between |
| of | X | Avatar | accessory, | avatar x, y | Y | Avatar | accessory, | avatar y, z |
| elements | | ID2, | clothing | | | ID2, | clothing | |
| | | Avatar | | | | Avatar | | |
| | | ID3, | | | | ID3, | | |
| | | Avatar | | | | Avatar | | |
| | | IDn | | | | IDn | | |

A method of ensuring that power at one or more servers of an IMS does not exceed a predefined maximum level, for a period of time, wherein the period of time is a sliding period of time, the method comprising: receiving media tags reported by a first UE and a second UE establishing a data channel session between the first UE and the second UE estimating a total energy expenditure of the data channel session between the first UE, second UE and the IMS, over a sliding time interval if the total energy expenditure of the data channel session exceeds the threshold during the sliding time interval, determining methods of reducing the total energy expenditure, wherein the methods include one or more of: rescaling input to a lower resolution, increasing or reducing processing at the IMS and output power consumption wherein for rescaling input to a lower resolution: the IMS instructs an encoding UE to rescale input to a level that below a level used in a previous time interval wherein for increasing or reducing processing at the IMS: the IMS performs more or less processing based on a determination as to whether the processing at the IMS is energy beneficial as opposed to processing at a UE, based on capability of application server hardware and software compared to UE operating system, application, codec, etc, wherein SIP messages are exchanged in an effort to control energy. The method described above wherein the method considers AI computation in combination with or in leu of video processing; wherein a server implementing a power control method is instantiated only upon certain thresholds being met, wherein the certain thresholds may or may not consider network side processing at the IMS.

The method described above further comprising training a ML model, based on sliding time periods applicable to other UEs of same data channel type, to determine whether to reduce input coding, reduce/increase network side processing and/or to reduce processing at an output device, wherein the ML model is trained based on the codec employed across the IMS, the Modulation and coding scheme used on both sides of the UEs, wherein the ML model is a vertical federated model.

The method described above further comprising receiving power parameters from the UE, wherein the power parameters includes: instantaneous power consumption and remaining battery power, wherein processing is offloaded at the UE such content provided to the UE is flattened.

The method described above, wherein the IMS instructs at least one device to sleep, upon detection of the total energy expenditure of the data channel session exceeding the threshold during the sliding time interval.

The method described above, wherein two UEs of a data channel session, provide SIP Invite and SIP Register messages which indicate support for total power reduction (network+UE side), wherein the media tag indicates same.

A method comprising receiving a media tag indicating support for drone control and a subset of attributes for the media tag. The method may comprise receiving a registration request originated at a non-UE device, for instance, a Low Earth Orbital satellite, high altitude systems, UAV, etc, wherein the registration request includes a capability of the non-UE device to perform sensing, data collection and adaptive network functionality; receiving a registration request from a UE, wherein the registration request is a request for a digital twin to be instantiated, wherein the UE in combination with another element disclosed herein provides the IMS with information for constructing, operating and receiving feedback from the digital twin, via SIP; Wherein media tags include: immersive 3d, sensory support, real world interactivity, holography, immersive social media, product delivery, content delivery, virtual meeting capability, healthcare device registration, autonomous driving over IMS, remote surgery, AIML over Ims, IoT over IMS, backscatter over IMS, edge over IMS, wireless sensor network, activity detection over IMS, positioning, enhanced latency, reliability, energy aware, robotic device registration, etc, or any combination thereof.

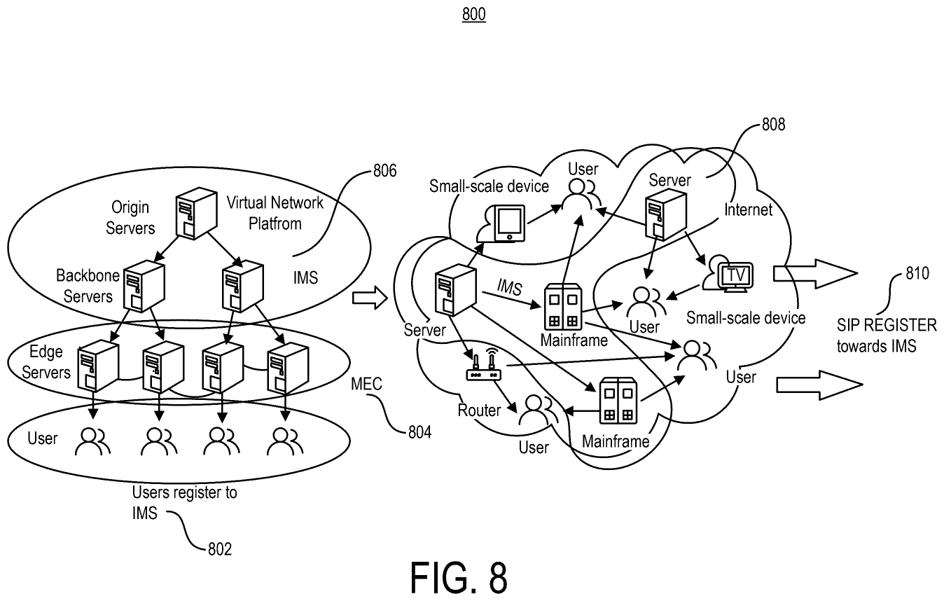

FIG. 8 is an IMS system drawing 800. In the system 800, users 802 may register to IMS 806 via MEC edge servers 804. IMS may comprise a plurlaity of servers and mainframes. Users and small scale devices may provide a SIP REGISTER 810 towards IMS.

### Reference Signal Allocation and Placement for High Altitude Nodes

IMS<->UE communication may involve high altitude platform station (HAPS), e.g. blimps, satellites, etc and Unmanned aerial vehicle (UAV) intermediaries which relay SIP and other messaging types to and from the IMS.

UAV-HAPS coordination: Frame and subframe formats for UE->UAV-HAPS communication may take the form of SBFD communications, TDD communications or FDD communications. For instance, data transmissions and receptions may be split in such a manner that a single TDD band includes control and/or data transmitted by to a HAPS node and a UAV node. For instance, a frame format (vertical freq. representation) may look like any of the following:

### Frame Format 0

TABLE 4
Frame format 0: Time −>

DL Control (from HAPS) w/Data
UL Data
DL Data (from UAV)

### Frame Format 1

TABLE 5
Frame format 1: Time −>

DL Control (from HAPS) wo/Data
UL Data
DL Data (from UAV)

A HAPS node may transmit a control channel (heard by both the UAV and the UE, while the UAV may serve data corresponding to the control information). In embodiments, a same DCI format may be used to convey resource information to both the UAV (in the downlink) and to the UE (receiving data from the UAV). An example DCI format is provided below. Each one of the following fields may have a fixed or variable length size (if variable a length indicator may be present or transmitted via RRC). There may be a need to provide more than one copy of each field depending on a number of receiving or transmitting devices.

TABLE 6
DCI parameters

| | |
|---|---|
| UAV indicator | Indicates a UAV relay |
| Carrier indicator | Indicates a carrier of one or more carriers of the |
| | UAV and/or the HAPS |
| BWP indicator | Indicates a bandwidth part of one or more BWPs of |
| | the UAV and/or the HAPS |
| MCS | An array of MCSs may be specified optionally, |
| | wherein the MCS may be different if there is |
| | dedicated data scheduled |
| New data indicator | |
| Redundancy version | |
| Frame format | Frame format employed between the UAV and the |
| | UE, e.g. SBFD, UL, DL. |
| TPC command | Value corresponding to an increment or decrement |
| | (or an abs. value). |
| TPC indicator | Indicates whether the TPC command relates to the |
| | UAV or to the HAPS |
| TPC PUCCH indicator | Indicates whether the TPC is for an uplink data |
| | transmission, or an uplink control transmission |
| Antenna port/num layers | |
| Transmission configuration indication | |
| Delay/doppler or time/frequency indicator | Binary Indicator specifying whether one or more of |
| | the DCI fields are indicated in terms of |
| | delay/doppler or time/frequency |
| Single carrier aggregation | Indicates whether an additional single carrier |
| | aggregation is performed on a tx/rx |
| Other parameters disclosed herein | Other parameters disclosed herein may be provided |
| | via DCI based on the conditions indicated |
| Reference signal scheduling information | Time/frequency/beam information for rs |

For carrier aggregation, a base station may use a same or different field to schedule a data transmission/reception on tdd resources as opposed to sbfd resources. For instance, a configurable number of bits may specify whether the allocation is for tdd carrier or a sbfd carrier (or a fdd carrier). If a bit length is greater than a threshold, sbfd may be used, for instance wherein an allocation provide resources for both uplink and downlink simultaneously. The same field may also be used, in the case of a number of bits being greater than a threshold to simultaneously schedule a tdd or fdd allocation. If the number of bits is below another threshold, the network node may intend to schedule a tdd or fdd allocation only. A same DCI format may be applicable to TDD, FDD and/or SBFD depending on an RRC configuration and number of bits specified for one or more fields of the DCI.

The DCI may have a CRC scrambled with an identifier that maps the UAV to the UE. For instance, the DCI may be scrambled with an identifier that is the product of an identifier of the UAV XORed with an identifier of the UE. In this way, both the UE and the UAV may receive the DCI. For instance, DCI may indicate two receivers, e.g. the UAV and a ground station, using a HAPS-UAV-UE RNTI. Alternatively, the DCI may be scrambled with an identifier that is assigned by the HAPS.

May schedule a TB to the UAV and a TB from the UAV to the UE on same, overlapping or similar resources (e.g. same slot different subbands), via a same DCI format.

HAPS transmitted DCI may schedule multiple UEs with same DCI and/or may schedule a transmission of one or more transport blocks to a plurality of UAVs for transmission to a single or multiple UEs. Same or different DCI from a HAPS may schedule inter-UAV communication resources, e.g. for resources between UAVs and/or between UAVs and UEs.

DCI may serve dual uplink/downlink purposes, e.g. for scheduling transmissions in both directions. In embodiments, a same DCI may schedule a transmission from the HAPS to the UAV and from a UE to a UAV using same or different resources of a single slot or multiple slots.

DCI may schedule transport blocks from both the HAPS and one or more UAVs. For instance, a single DCI may schedule transport blocks from the HAPS and two UAVs assuming the two UAVs are in range to the UE. The UE may provide CQI directly to the HAPS or via the UAV, depending on RRC information broadcast by either device. The timing may be fixed or may be configured based on control signaling transmitted by the HAPS. The control signal may indicate a resource for additional DL control signaling of the UAV, resource(s) for UAV data and one or more resources for ACK/NACK bit(s). The control channel (e.g. DCI) transmitted by the HAPS may indicate resources for UL and/or DL transmissions by/to ground based UEs or other-non ground based devices. The HAPS and UAV may negotiate a number of UEs the HAPS may serve and the HAPS may negotiate with another HAPS a number of UAVs that each HAPS may serve in a given area. There may be a given number of devices per device class, e.g. IoT devices vs. URLLC devices which each device may serve. In embodiments, a maximum number of serving devices may be determined based on a number of intermediary connections, i.e. UAVs serving a single UE. A HAPS/UAV may employ a low power wide area or a higher lower low latency type network, depending on thresholds as described herein.

U.S. Pat. No. 11,985,6111 to Worters et al. is amended herein. A method comprising: receiving, by a user terminal, a downlink radio frame transmitted by a satellite, wherein the downlink radio frame comprises a target time for an uplink radio frame from the user terminal and one or more additional uplink radio frames from one or more additional user terminals to arrive at another node having an altitude between the satellite and the user terminal; determining, by the user terminal, a downlink propagation delay associated with the downlink radio frame and an uplink propagation delay associated with the uplink radio frame to be transmitted from the user terminal to the another node; determining, by the user terminal, an uplink transmission delay indicating an amount of time to delay a transmission of the uplink radio frame to the another node, wherein the uplink transmission delay is determined for the uplink radio frame to arrive at the another node at the target time, wherein the target time comprises a same target time as the one or more additional uplink radio frames from the one or more additional user terminals; transmitting, by the user terminal, the uplink radio frame at a time corresponding to the uplink transmission delay. In embodiments, the another node is a UAV, blimp or another satellite.

U.S. Pat. No. 11,949,496 to Chen et al. is amended herein. A method comprising: receiving, by a satellite, a schedule of communications between the satellite and one or mobile nodes located at an altitude between the satellite and the ground, wherein the schedule of communications is based at least in part on ephemeris data associated with the satellite and information concerning the trajectory, speed and location of the one or more mobile nodes; requesting, by the satellite or the one or more mobile nodes, based on the schedule, a handover from a communication link between the satellite and the one or more different mobile nodes to a different communication link between the satellite and the one or more different mobile nodes, a subset of the one or more different mobile nodes or a mobile node not of the one or more mobile nodes; performing the handover; and after the handover, transmitting, by the satellite, one or more packets via the different communication link. In embodiments the schedule of communications includes information regarding one or more ground stations with which the one or more different mobile nodes are in communication with.

In embodiments, a method performed my encompass: 1) estimate a drone in an area based on signaling, e.g. ISAC, movement, imaging, etc. 2) determine that the drone should be identified 3) attempt to make signaling communication with the drone 4) if signaling communication is unable to be made, provide signaling, e.g. to a satellite or other communication node, to instruct drones to provide a remote identification feature, e.g. a comb pattern or ZC pattern for a period, in a direction or area. 5) determining, by the drone, whether to include the pattern and how often to transmit the pattern in transmissions based on its own serving data; 6) ground units receiving the pattern may estimate a drone location based on modulation parameters, data transmission parameters, etc.->can identify a type.

US20250088830 to Vassilovski is amended herein. A method of wireless communication performed at a user equipment (UE), the method comprising: transmitting, to a UAV, activity information associated with the UE; receiving, from the UAV, an indication of a transmission frequency for transmitting a notification wherein the indication specifies a periodicity and timing information corresponding to the UAV and a HAPS, wherein the transmission frequency is based at least in part on the activity information associated with the UE; and transmitting the notification to the UAV or to the HAPS associated with the UE, based on the transmission frequency. Further comprising: receiving, from the network unit, an indication of a second transmission frequency for transmitting the notification, wherein the second transmission frequency is different from the transmission frequency and the second transmission frequency is associated with transmissions to only one of the HAPS or the UAV; and transmitting the notification based on the second transmission frequency. Wherein the notification comprises information disclosed herein. Drones/UAVs may provide communication enhancements to a network, but may also provide hardware enhancements to the network, for example, by supplying hardware acceleration capabilities.

U.S. Pat. No. 11,757,526 to Chen is amended herein. A user terminal comprising: one or more processors coupled to a memory, the one or more processors being configured to generate an initial network entry request based on a location of the user terminal and assistance information provided by a ground station; an antenna assembly configured to find, in response to the initial network entry request, a satellite or another HAPS based on a search of a sky, wherein the search of the sky comprises sequentially changing a beam pointing direction of the antenna assembly in search of the satellite and the HAPS wherein the sequential search alternates a beam pattern between a beam used for finding the satellite and a beam used for finding the HAPS, wherein the satellite is assigned to downlink to a geographic cell associated with the user terminal and associated with the ground station; and a media access control (MAC) layer component configured to generate an uplink radio frame including a random access channel (RACH) request associated with the initial network entry request at a particular portion of the uplink radio frame for the satellite, wherein the particular portion is selected by the MAC layer component from among a plurality of portions of the uplink radio frame, wherein a same MAC layer is employed for communication with the satellite and the HAPS, wherein in some cases, the MAC layer establishes a dual connectivity scenario between the satellite and the HAPS for a period of time with which both nodes are in range of a subset of a set of beams of the user terminal, wherein the subset of beams is restricted by the ground station.

In all cases, a two stage DCI system may be in place, based on KPI (e.g. sensing KPI), wherein a first DCI schedules some resources and resources for a subsequent DCI (which schedules other resources). In embodiments, either DCI may employ fields herein and two (or more) stage DCI may be configured via RRC as opposed to one large DCI format. In any case, the DCI may schedule a number of rounds of integrated sensing, e.g. it may schedule configured grant/dynamic sensing resources and those resources may be cancelled on the condition that an object is located by a device which transmits the DCI (or SCI) or the dynamic resources may be cancelled by way of another device detecting the object based on a certain threshold parameter being met. The DCI (primary or secondary DCI) may signal such threshold information or it may be that the DCI(s) schedule resource information for further sensing by another device and/or resources utilized for providing results of the wireless transmission to a UE or to the sensed object itself. DCI may include or may indicate detection thresholds including channel response, target-presence, and target properties (e.g., position, shape, size, velocity, etc.) may be estimated as per US20250088890 to Hu. Based on a detection likelihood, the resources may be cancelled. In other embodiments, a DCI may schedule resources for sensing an object and for triggering an object to wake up. For instance, the DCI may include multiple different time/frequency allocations and may suggest a modulation and coding scheme for the transmissions to/from a sensed device. On the condition that the device is found, the resources for communicating with the device may be employed. Otherwise, one or more devices involved in the sensing procedure may transmit a cancellation DCI indicating the resources to be cancelled on the condition that the device has not been found or on the condition that another device has been found. For instance, a DCI may schedule sensing transmissions with identifiers for multiple different devices to be searched. In this case a DCI may provide a list of parameters, e.g. identifying objects to be located and a number of objects to be found. On a condition that at least one of those objects are found, communication resources may be utilized to communicate with the object or to perform further sensing of the object. The dci may specify which resources are to be associated with which object and, if an object is identified, additional (non used) resources of the first search may be dedicated to the second or subsequent search for another object. In certain cases, a clear channel assessment procedure may be performed for sensing of some objects and not others. The dci may indicate whether or not to perform CCA on particular resources, beams, objects, or by certain device types. For instance, assuming the DCI is transmitted to more than one receiver, depending on a receivers operating frequency, there may or may not be a CCA procedure performed beforehand. The receiver may indicate whether CCA was successful or not, or it may simply perform the procedure and report back as to the threshold likelihood of detection.

In embodiments involving two base stations performing sensing or scheduling more than one UE for sensing, a same or different RNTI may be employed for the primary DCI and the secondary DCI. Similarly, a same or different RNTI may be employed for each sensing DCI transmission provided to two or more UEs. A first DCI may schedule resources for sensing and resources for a second DCI, wherein the second DCI is a cancellation DCI transmitted by the same or different transmitter. The cancellation DCI may be transmitted when a resource need is high, e.g. a latency is low and/when a threshold object detection level is met. For instance, a medium threshold object level may be met, but when a low latency transmission has a need, the resources may be cancelled. If a low threshold object detection level is met, and the same low latency transmission need is determined, the sensing resources may take priority.

A UE determines to communicate directly with the HAPS or the UAV, based on an indicator in the DCI and a power control value. UE may maintain two or more power control states, e.g. one for each HAPS and one for each UAV.

The system may optimize for latency, e.g. using uplink directly to the HAPS, or may optimize for power efficient transmission, e.g. by limiting uplink power to UAV nodes.

A UE may receive a primary downlink control information (DCI) from a NodeB (gNB), the primary DCI scheduling one or more secondary DCI, wherein the secondary DCI is one of an uplink DCI or a downlink DCI or a combination thereof, wherein the secondary DCI schedules a PUSCH transmission to a satellite node or a PDSCH transmission from a satellite node, wherein the secondary DCI indicates terrestrial resources for acknowledging receipt of the primary DCI and/or the secondary DCI. In embodiments, either DCI may indicate information here.

Sherief Helwa describes improved acknowledgement mechanisms in “Improving Acknowledgment Mechanisms” dated Mar. 10, 2025. Helwa describes that a block ack bitmap may be modified to include unavailability information. Such technique may be performed in acknowledgement modes in Bluetooth, cellular and satellite methods. In particular, a network node may configure the length of an acknowledgement frame (after a condition is met, e.g. an rsrp threshold is met) that the length of an ack frame should be expanded to include additional cause information, wherein some bits may configure a cause to be indicated as device specific rationale as correlated to the devices reported capability information. For instance, if a device reports a capability to perform hardware acceleration, then an ack may dedicate a particular bit to a hardware acceleration error as being the cause of a missed transmission/reception. Alternatively or in combination, if the device has a processing error, memory error, or display error etc. the device may report, in an ack, the reason for missing a reception or may transmit a subsequent message indication a rationale for failing to transmit. Similarly, a frame indicating a percentage of nacks derived from wireless loss as compared to internal or other event caused loss, this may be periodically requested over a sliding period of time.

Scattering Based Full Duplex and/or SBFD MIMO Transmission

In embodiments, a UAV may discover scatters, e.g. via a determination of the birth and death of multipath components (MPCs) as is disclosed in Predicting Lifespan of Ground-to-Air Multipath Components in mmWave UAV Channels by Wahab Khawaja et al. The scatters may be used for location determination purposes and for scheduling purposes. DCI may allocate resources based on time, frequency and scatter based sources. Timing may be in accordance with a receive timing at a end device, based on scatter timing, e.g. based on a signal time of arrival per scatter source.

In embodiments, a HAPS may indicate to a UAV that allocations to UEs and base stations may be performed on a scatter basis. For instance, a UAV may determine a scatterer based on previous signaling or reference signaling and allocate a scatter, via DCI signaling, in both uplink and downlink communication as the scatterer(s) become available or are estimated as likely to become available, e.g. based on previous multipath determination via flight patterns.

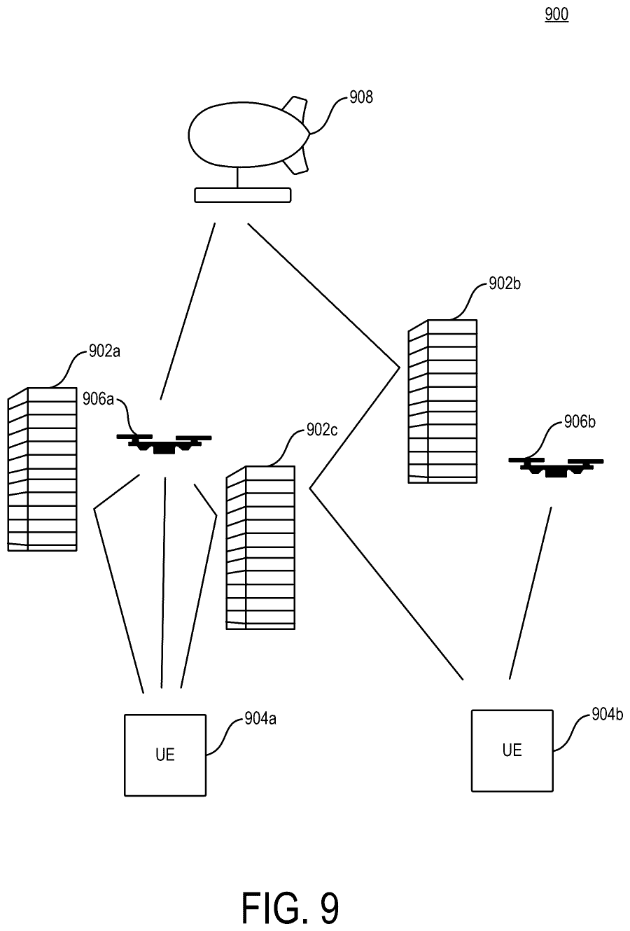

FIG. 9 is a drawing 900 of various UAV devices in a city. For example, a blimp 908 may be in direct communication with UAV 906a and may be in indirect communication with UAV 906b via UE 904b UAV 906a may be in direct communication with UE 904a and/or via reflection from buildings 902a, 902c. Buildings 902b, 902c may reflect signals from blimp 908 to UE 904b.

For instance, a single or multiple DCI transmissions by a UAV may allocate resources for an uplink transmission, downlink transmission and sidelink transmission (e.g. to another UAV) by separating transmissions according to scatterers. The resources may be on overlapping frequency components or may be separated, e.g. in a SBFD type frame where different portions are located on uplink or downlink (or sidelink) portions of a slot.

In the example shown, a HAPS may coordinate with a UAV to provide scheduling information directly to the UE or via a UAV relay such that the scheduling information allocates three different data streams to the UE in same or different directions, based on the scattering environment. For instance, if the UE may detect three unique data streams transmitted by the UAV, the UE may report a CQI indicative of each stream to the UAV and the UAV may report a joint ability for the UE to report a number of streams based on the CQI being detected above a threshold for each stream (which is associated with a scatter or line or site link). Once it is clear that the UE may receive a signal above a threshold for a plurality of links, the UAV or HAPS may instruct the UE, via the UAV, to switch to a full duplex mode wherein the UE transmits and receives on same (or closely linked) frequency components. It may also be that the UAV is full or subband duplex in its communications with the HAPS and UE simultaneously. HAPS may provide DCI that indicates a UAV identifier or a spatial identifier. In the case of a spatial identifier, there may be multiple UAVs in a given space or area and instead of control signaling being interpreted only by a UAV with ha given identifier, a UAV space may be provided such that any UAVs in that space may receive and interpret the DCI. For instance UAVs may be assigned an RNTI based on an xy coordinate plane and a given distance(s) in z, y or z space. Upon entering such a space, the UAV may monitor for DCI coded with the particular RNTI associated with a location. This way, the UAV may also determine an RNTI without actually being preassigned, however, the HAPS may provide control signaling, e.g. RRC signaling, indicative of the x, y and z components, distances, or areas. If there are multiple UAVs in such an area, it may be that a group based RNTI is used and/or the DCI may contain control information indicative of de-duplication information (e.g. what to do upon the UAV detecting that other devices have also received the control signaling).

Single or Dual HAPS and UAV configurations may employ pilot or reference signals that are spread in the delay doppler domain as per either option disclosed by FIG. 2 of A low-PAPR Pilot Design and Optimization for OTFS Modulation by Davide Bergamasco et al, disclosed herein by reference in its entirety. For instance, reference signals may be provided using an OFDM technique by one device and a delay-doppler technique by another device. In embodiments, a pilot sequence may cover a portion or a whole column of an OTFS frame, while another pilot signal transmitted by another device is transmitted with a correlation. For instance, one device may specify or signal a pilot configuration for another device, wherein one device operates in OFDMA and a pilot signal is transmitted via an OFTS frame configuration. In embodiments, both devices may employ column based pilot signals for integrated sensing, data transmission/reception, control transmission/reception, and the like. For instance, a UE may receive a QCL type and be configured to monitor signals based on the QCL type, e.g. QCL type a, b, c, d etc. There may be more than 4 types depending on channel access scheme. Depending on whether a signal is QCLed in an OFDM or OFTS scheme, one or more signals disclosed herein may be transmitted on demand. Similarly, a placement of pilot signals may be correlated with a periodicity with which those pilot signals are transmitted and with a power in which those signals are transmitted as it relates to other data/control symbols.

In embodiments, a OTFS pilot signal scheme, e.g. pilot resources organized in a delay doppler domain may be quasi collocated with other resources and such quasi colocation may be indicated periodically using unicast or groupcast indication, via transmission of control or data signals by a satellite or other HAPS, by a base station or by the UE (for instance for uplink indication or for UE->UE communication). A certain configuration of pilot signals may be indicated in advance, for instance, via RRC signaling, including via SSB transmission (either in data portions of an SSB or via control signaling, e.g. a shift or change in control transmission).

In embodiments, the HAPS may indicate that a UAV is to employ its own control signaling without receiving DCI from the HAPS. In some embodiments, HAPS may provide control signaling directly to ground based UEs absent control signaling being provided by each UAV individually. The UAVs may simply transmit/receive a data channel(s) based on the DCI provided by the HAPS. In this case, the DCI may be coded according to UAV RNTI and the UEs may find control information within the DCI that matches their own identifier. In response to receiving transmissions, UEs may report precoding matrix indicators which allow the UAVs to isolate transmissions to multiple UEs using overlapping time/frequency resources. There may be a limited subset of PMI information provided from the UAVs to the HAPS for the HAPS to determine how well the PMI based separate is working.

A network node may preempt transmissions, wherein some devices are using a time/frequency method and other are using a delay/doppler scheme by indicating transmitting a same DCI format indicating pre-emption resources described in terms of time/frequency and other resources described in terms of delay/doppler, wherein the set of time/frequency devices may not interpret the delay/doppler specified resources. This assumes the pre-emption indication employs a group RNTI, but in cases, the DCI format may be repeated to individual users using a UE specific RNTI. Assuming that resources are shared between devices which recognize delay/doppler and devices which only recognize time/frequency, either technology may schedule pre-emption resources indicative of resources pre-empted on the other technology, depending on a latency requirement for transmission/reception of a particular UE.

In relay embodiments, it may be that one device recognizes delay doppler scheduling, e.g. a relay device, while an end UE only recognized time/frequency. Thus, the relay device may receive scheduling information from a transmit node with a delay/doppler allocation and the DCI may schedule time/frequency resources for retransmission of data received at the relay. Similarly, the reverse side is also true in that the relay may receive time/frequency allocated resources from an end UE and may retransmit those resources using a delay doppler method, wherein all resources are scheduled by either the relay, the UE or the network node.

Relay devices may be TDD and FDD compatible to SBFD relay devices and/or relay devices may be SBFD to FDD and/or TDD relay devices, depending on the requirements of end point relays. For instance, transmitting devices may provide downlink control information corresponding to a TDD/FDD transmission (FDD e.g. when two signals are receiver on different frequencies), and the relay devices may autonomously determine which resource types to perform retransmission on. Alternatively, the relay devices may be controlled by dci provided by the transmitter and/or uci provided by the receiver. For instance, the UCI may provide a preferred channel or receive type (channels in the case of FDD, or TDD, etc). Based on load on the relay, e.g. a load threshold, relay devices may need to retransmit the signal in a same or similar format as it was received on, e.g. sbfd. If, for example, a SBFD compliant relay performs a full duplex retransmission, there may be a need for gaps in time.

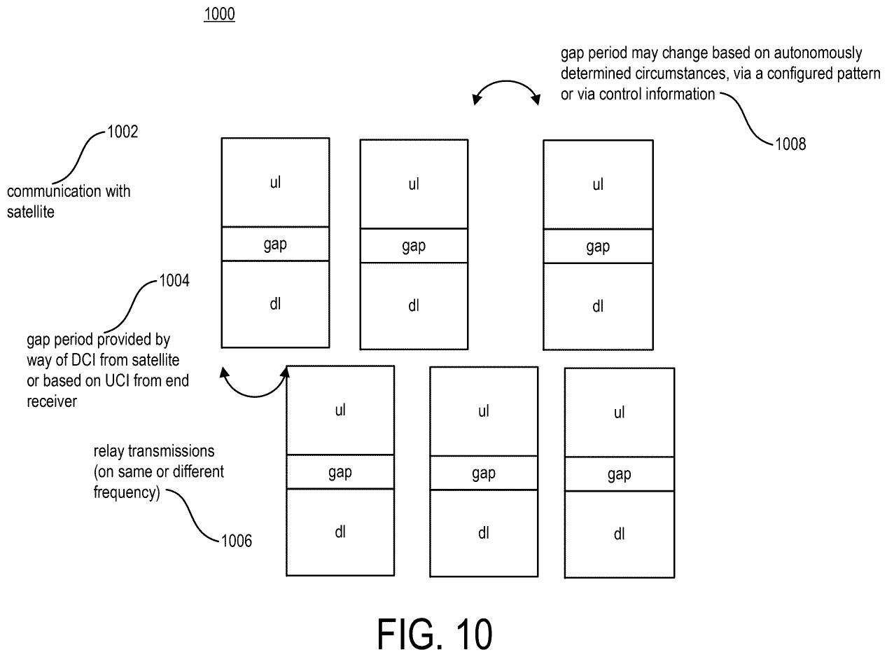

FIG. 10 is an illustration 1000 gaps in satellite and relay transmissions. In embodiments, a satellite node may provide uplink or downlink signaling having a gap period which may change 1008 based on circumstances determined by the satellite node or otherwise. The gap 1004 may be in time or frequency. A UE and/or relay device may be in communication 1002 with the satellite and may receive a gap period reflective of a time difference between the transmission/reception of the signal provided by the satellite and a relay transmission 1006 of the same or altered signal.

There may be a need for a single power transmitter to transmit power to multiple receivers simultaneously or near simultaneously, e.g. via power switching procedures. The transmitter may prioritize devices which need charging based on their current power level, an expected change in power level at a future time instant.

For instance, a device may report, in a packet format: a power status report, e.g. comprising one or more of the following fields:

TABLE 7
Power status report

| | |
|---|---|
| Minimum power receive | This may be a bare minimum power need, e.g. a |
| | minimum power required to maintain information in |
| | RAM |
| Power save | This may be a minimum power level needed to |
| | perform basic tasks, e.g. respond to |
| | communications, transmit periodic signals, but may |
| | consume less power than an operational mode |
| Operational power level 1:n | A number of operational power consumption modes |
| | may be reported in a single IE along with the |
| | number n of modes |
| Software update mode | Power requirements for a receiver or associated |
| | device to perform a software upgrade (which should |
| | not be fail during download but must not fail during |
| | switchover to new code) |
| Maximum power level | Max power |

A registered device may transmit a request to an IMS for the IMS to provide a third party with a link to a secure eSIM and/or profile information for performing the following actions outlined in 3GPP TSG-SA WG2 Meeting #168, S2-2503101, Goteborg, Sweden, Apr. 7-11, 2025. Subject to operator's policy, the 5G network shall be able to provide secure means to report sensing result to a trusted third-party requesting information about a target object when specific requested conditions are met. Subject to operator's policy, the 5G network shall provide secure means for a trusted third-party to request 5G wireless sensing service based on specific parameters (e.g., refresh rate, period of time, sensing KPIs, geographical location) and to receive the corresponding sensing results. Subject to operator's policy and regulation, the 5G system shall be able to provide secure means for a trusted third-party to receive sensing results with contextual information. Subject to operator's policy, the 5G network may provide secure means for the operator to expose information towards trusted third-party on whether a given sensing service is available and the estimated quality of the given service for a certain geographic area and time. Subject to operator's policy, the 5G network may enable secure means for a trusted third party to provide sensing assistance information. An eSIM may be provisioned for the third party, for a limited time only, to get or put information onto an application server of the IMS. The eSIM may be provisioned for a limited time, depending on the sensing procedure. The eSIM may participate in sending a coded sensing signal or receiving a coded sensing signal in response to the transmission of a signal by another UE or BS. If the trusted third party is already a network subscriber, the trusted third party may transmit a registration request to register for any one of the parameters described above. Based on the registration request, the IMS may reach out to another subscriber, the subscriber who is a primary subscriber, and initiator of the sensing, to request access for the trusted third party. Assuming, a request is granted, the IMS may relay certain information to the trusted third party.

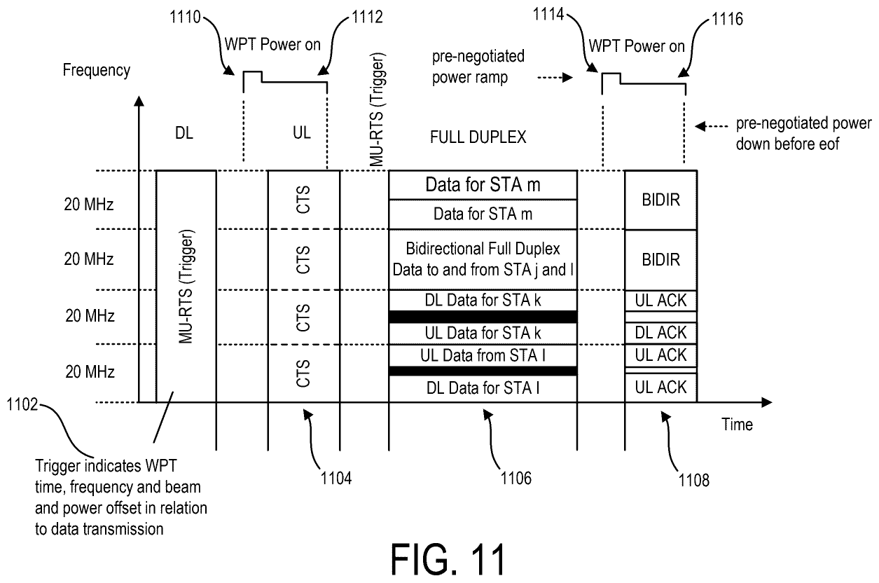

FIG. 11 is an illustration 1100 of power application in wireless power transfer applications. A WiFi trigger frame 1102 may be modified to schedule power transmissions along with a data and control transmission schedule to one or more scheduled devices, wherein some devices may be power receivers and some devices may not be power receivers. For instance, the trigger frame 1102 may be modified to provide power for STAs to receive data frames, transmit data frames, and receive and transmit control frames. For instance, the trigger frame may provide an indication as to when a power signal may be provided, e.g. as an offset to the data or control frames. Similarly, the trigger frame may provide an indication as to whether the power signal is quasi collocated with the data or control signals or periodic reference signals therein such that the trigger frame may omit the particular beam information for one or both of the power transmission and the data/control transmission/reception. For instance, if the receiver knows that the power tx is quasi collocated with another signal, there may be no need to expressly indicate a beam for one or both signals. The power receiver may deduce, from the frame sequence triggered, that certain power signals may be preamplified (e.g. ramped) so as to provide power. This may be true in the case of data transmissions of the power receiver or it may be true in the case of receptions. In some cases, a power pre-ramp signal may be omitted in scenarios wherein a maximum power level is expected to be exceeded. In some cases, when the power transmitter, e.g. an AP or BS, is transmitting power to a pair of sidelink communicating devices, when a maximum power level is expected to be exceeded, the AP may reschedule the sidelink transmission for a later point based on a QoS or priority threshold, alternatively or in combination, the AP/power transmitter may reduce power transmission only in the case where there is an expected battery level present at one or both power receivers such that the transmission may still occur with a given probability (e.g. a probability threshold).

Specifically, a trigger frame 1102 may provide scheduling information. A power may be ON by the AP, for example, for stations to return a CTS transmission 1104 on resources indicated by the trigger frame. Data transmissions 1106 may follow the CTSs wherein power may or may not be on for such transmissions as indicated by the trigger frame, depending on a need for STA receive and transmit power. Lastly, power may be provided for acknowledgement signaling 1108. When wireless power transmission is applied, the trigger frame may specify power parameters for a period. For instance, the trigger frame 1102 may specify that WPT power is high for a brief period 1110 followed by medium for a period 1112. Similarly, WPT may be high 1114 prior to falling 1116. The WPT power applied may vary across a transmission time interval in both the time and frequency domain.

AIML models may be established, transmitted and received. The AIML models may relate to beamforming and CSI as it relates to a location within a network, both in terms of a UE location and also in terms of a network node location at a given time. For instance, it may be well known that a particular satellite is at a given location at a given time, but may not be well known that a UE is expected at a particular location at a particular time.

In 6G embodiments, always on reference signals may be transmitted less frequently than in 5G. For instance, SSB may be transmitted less frequently and/or may be transmitted on fewer symbols. For example, an SSB may be PBCH-less, e.g. only synchronization signals may be transmitted and the UE may determine certain information about the cell by way of the synchronization signals (and by way of lookup via another UE, via lookup from another BS, based on hardcoded information, or the like.) Absent PBCH, a UE may receive a third synchronization signal that indicates uplink resources for transmission of RACH uplink requests for the PBCH in a given direction. So the RACH may indicate a preferred beam (or the RACH resource selected) may indicate a preferred beam and the BS may respond with minimal PBCH (or large PBCH depending on UE type or need for fast connection) such that the UE may continue with cell synchronization and initial access. The UE may receive PBCH or other information on demand or it may be that in some cases, e.g. for certain portions of the PBCH, the PBCH is broadcasted in the cell (omnidirectional or directional beam) for at least the certain PBCH that may be commonly used among UEs. It may be that the UE gradually learns of certain PBCH contents over a period of broadcast transmissions over time. The UE may piece certain aspects together instead of transmitting its own on demand request. The UE may start a timer for a certain information element, e.g. if it does not receive the IE in a broadcast transmission, the UE may send an on demand request. This way, if the BS or network node is periodically sending the information in directions based on a request, the UE may hear the information by way of transmission to another device.

A satellite may indicate its capability to perform handover based on transmitting a synchronization signal(s), for example, if a synchronization signal signifies that same parameters will be employed for future satellite devices which take its place, a UE may receive a MIB/SIB from the satellite and then make a decision to camp on a different satellite. In embodiments, a satellite may convey a primary cell identifier which varies over time. So, for instance, the comb indicates an identifier into a look up table for identifying which satellites will take the place of the satellite at what instants in time. In embodiments, a satellite receives one or more synchronization signals from satellite 2 and performs a switch without changing of a PCI, wherein the second cell takes over the cell at a given instant identified by synchronization signals themselves. In embodiments, when a change is within a certain threshold of time, the PSS and/or SSS indicate change, but when more time may elapse until a change, there may be a connotation of the change in the MIB/SIB. In that way, an SSB may indicate timing for switch to occur in different scenarios.

A synchronization signal may convey a configuration change count value of the cell. For instance, a sync signal which is transmitted either on demand or periodically may include or indicate an integer value representing whether or not PBCH IEs have changed over a period of time. This way, on reconnect, the UE may receive the sync signal and determine that it need not transmit a request for new system information. The base station may increase the counter value itself upon a change or it may receive an indication from the network of a new value or a change to the value.

The Network may configure a steering policy for wifi/voice/sms, etc. including for steering between VoLTE and VoWiFi and voice/data service of 3GPP satellite compared to voice/data service over a 3^{rd} party satellite (e.g. starlink, etc).

The UE may report a capability to perform adaptive (e.g. network configured) traffic steering to the network, e.g. to an IMS, via SIP. The UE may report certain configurable options, e.g. the UE may report that a number of interconnected devices, tables, pads, computers, watches, display devices, glasses etc. are associated with the UE and the traffic types, QoS and QoE expectations for which each device is expecting. The UE may report whether one of the devices supports operator configurable traffic steering despite not being directly cellular enabled. Each device may have its own subscription to a MNO, e.g. to a satellite MNO, Wi-Fi MNO or it may have a Bluetooth connection or other type of connection to the internet.

In response to receiving capability information as to device configurability, a network may configure certain parameters in certain conditions. UEs may indicate whether wireless base stations, e.g. WiFi APs, are configurable by the MNO, based on the capability report. For instance, an owner of the AP may allow a certain MNO or set of MNOs to control policies of the AP. In the case of a set of MNOs, there may be an operator of the AP, e.g. comcast for example, and an MNO, e.g. Verizon (which is the cellular MNO of the owner of a UE associated with the AP). In this way, Comcast may limit configurability of the AP to Verizon and may only allow a subset of all configurable AP information elements to be controlled by the cellular MNO.

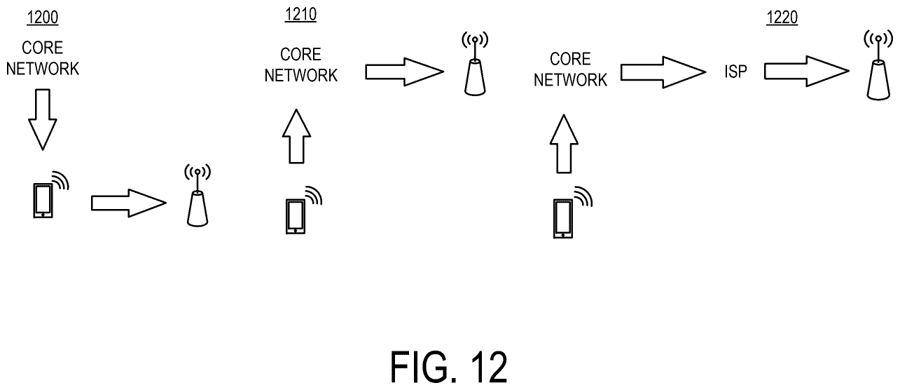

There may be four (or more) methods for a UE to grant an MNO access to an AP. FIG. 12 demonstrates Core network, BS signaling and UE signaling examples 1200, 1210, 1220. In example 1200, access may be provided via the UE, wherein the UE receives configuration parameters from the MNO and configures the AP on its own; In example 1210 access may be provided between the MNO and the AP, with the UE providing access parameters to the AP via the cellular link; and in example 1220 access may be provided between the MNO and the internet access provider of the AP (e.g. Verizon->Comcast->AP). In this case, there may be an interface between the UE and Verizon, between Verizon and Comcast and between Comcast and the AP. Satellite providers may provide internet service to others, via a ground relay station/device.

In embodiments, a wifi AP may lack a ground connected ISP and may instead have satellite only access such that wifi configuration parameters (and other configuration parameters) are controllable by MNOs including the MNO operating the satellite service. An AP may be served by two satellite providers, one which implements a cellular backhaul and a NAS configuration (e.g. Verizon) and one which does not have a cellular backhaul/NAS configuration (e.g. starlink). A N3IWF may reconfigure an AP, satellite, or other node described herein.

In embodiments, a DCI may indicate a pattern (e.g. a segmentation or interleaving pattern) and that pattern indication may be associated with a plurality of MCSs, such that the DCI need not indicate which MCS since it indicates the pattern instead. Resources may be mapped according to the one or more MCSs. See, for example, 6GWS-250065.

US20100260161 to Van Veen discussed some inter-codeblock work with turbo coding, but this should be extended to other coding schemes, e.g. LDPC and polar codes. Van Veen is amended herein. A method of transmitting a plurality of codeblocks in a communication system, the method comprising: LDPC encoding a plurality codeblocks using one or more different types of LDPC encoders to generate a plurality of LDPC codeblocks, wherein the encoding employs shared parity bits among the codeblocks; interleaving each of the plurality of LDPC encoded codeblocks using a bit interleaving scheme; and transmitting the plurality of LDPC encoded and interleaved codeblocks. In embodiments the different types of LDPC encoders are selected from the list of regular, irregular, binary, and non-binary. Each type may be based on a lower triangular or double diagonal parity-check matrix structure (e.g., lower-triangular, double-diagonal), which may be indicated by DCI. The different types of encoders may be signaled via RRC, MAC or DCI layer signaling and may be applicable to both dynamic and configured grant transmissions. Example coding techniques include matrix method, iterative encoding, block circulant and or Richardson-Urbanke. Certain redundancy versions used may rely on parity bits left in a circular buffer, while systematic bits are replaced on subsequent transmissions.

Redundancy versioning may be differently selected when ISAC and data transmission are integrated as opposed to when data transmission is sent absent an ISAC coding. For instance, redundancy versioning may be based on a need for ISAC, e.g. a priority of the ISAC vs data signal.

In embodiments, a change to a code mid transmit stream may be used to initiate or deactivate a sensing signal. In embodiments, a data transmission may be coded to convey to a receiver that an ISAC transmission is integrated with the data stream or that the ISAC transmission is quasi collocated with the data stream. Employing ISAC sensing simultaneously with harq or arq responses may be employed as well, for instance, depending on a signal quality and a type of acknowledgement frame employed. For instance, ISAC sensing may be employed when transmitting ACKs but not NACKs or vice versa. The UE and/or base station and/or network node may employ a codebook selection process based on a need for sensing. For instance, the UE and network node may evaluate whether there is a need for sensing and a priority of the sensing signal and the data signal and may may receive a codebook accordingly. In embodiments, selection may be based on signaling received via DCI, SIB and other RRC based signaling.

In embodiments, RRC and/or SIB may provide transmission patterns that indicate a transmission duration of the ISAC signal encoded with a data signal. There may be an allow or disallow pattern provided, e.g. an allow or disallow pattern may specify frames, frame types, subframe, slot, etc. that are allowed to employ joint ISAC and data transmission coding. DCI may schedule resources for ISAC and separately or jointly for data transmission.

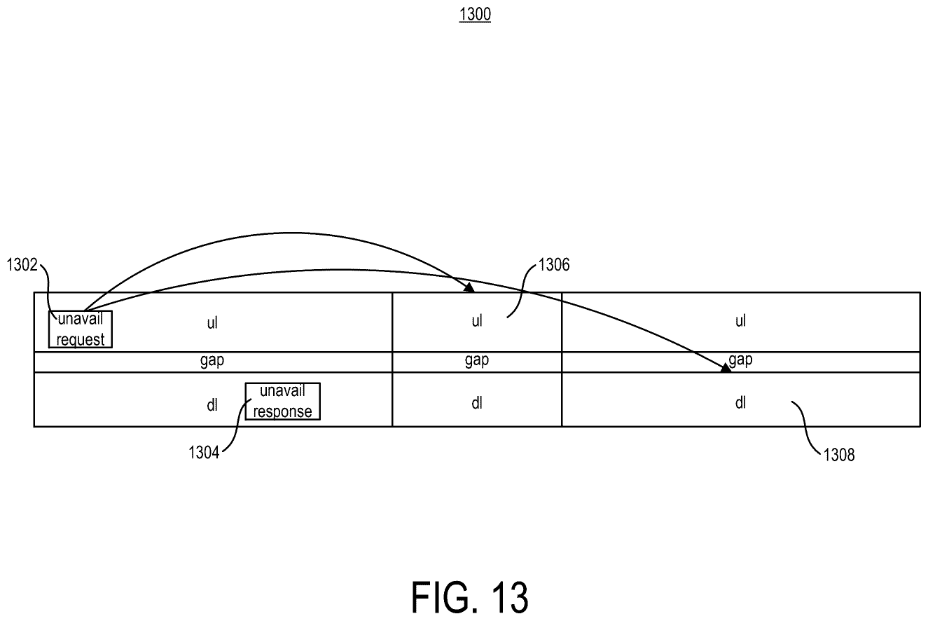

FIG. 13 demonstrates unavailability signaling 1300. For instance, a device may transmit an unavailability request 1302 in the UL portion of a SBFD slot and may receive an unavailability response 1304 in the same slot or different slot. The unavailability request may indicate an unavailability for an UL portion 1306 of a SBFD slot and a DL portion 1308 of the next slot.

Different code blocks may be used in SBFD

TDD, FDD and/or SBFD slots may be used in such a way that different inter-codeblock combinations may be placed in disparate slot formats. For example, LDPC encoding wherein multiple codeblocks are coded based on same parity bits may be placed in certain slot formats only, while other codeblocks separately coded may be placed in other slot format types, wherein some slot format types may or may not follow one another in time/frequency.

Code block group retransmission may apply differently for equal or non-equal size code blocks, based on DCI format, DCI signaling parameters, resource scheduling parameters, etc. In cases where inter-codeblock parity coding is employed, a same or different lifting size may be used for a period, set of frame(s), number of transmissions, etc.

In an embodiment a first DCI may schedule transmission of a codeword, a second DCI may schedule transmission of a plurality of codewords, wherein the DCI indicates that the plurality of codewords share parity bits; processing the codeword and the plurality of codewords; and indicating a request for retransmission of the codeword and a subset of the codewords, wherein a retransmission of the codeword and the codewords occurs using same or different parity bits. In embodiments, DCI schedules resources for ACK/NACK of the codeword and codewords jointly or separately, based on other scheduled transmissions such that a same or different set of parity bits may apply to the ack/nack bits as other uplink control or data signaling. In embodiments, a SBFD frame structure is employed.

In embodiments, a circular buffer may be employed for storing code blocks as they are arrived. In embodiments, a code block or code block group retransmission request may be provided in addition to or alternatively from a transport block. If a code block or code block group is retransmitted, then it may be that the retransmission (based on a received RV), is provided based on a different selected encoder, a same selected encoder, a same set of parity bits or a different set of parity bits. For example, there may be a change in parity bits (again based on RV) when a new codeblock is sent which does or does not share parity bits with other code blocks. So, in a first transmission a codeblock may share parity bits but in a retransmission, a codeblock may have dedicated parity bits based on configuration.

In embodiments, an app integrates with a sim->so once a SIM is downloaded that matches the app, via a hash code, when code of an app is executed, the sim is activated. eSims may be verified upon boot up and the code which calls them may also be verified and periodically verified.

There may be an association between App client: SIM profile: device identifier. In embodiments: 1. log into an app store; 2. choose an app to download. The app store provides eSIM associated with the app being downloaded OR as the app is downloaded, if the OS determines that a required eSIM is not located on the device, the OS downloads the eSIM from the carrier, app provider or app store based on a correlation of the app client and device capabilities.

Regarding secure authentication, an identifier of the esim is provided by app store to app developer->app developer can verify the device based on knowing that the subscriber is registered with the network pursuant to the esim, wherein the esim is associated with account details including: a phone number, email address and user identifier. these identifiers are all associated with the esim (and the carrier), thus a same phone number, email address and user identifier may auto register for the application itself.

The app developer may require a certain esim or category of eSIM be loaded on the UE device, such that it gives the app control over network functions associated with the app. In embodiments, the network functions may be directed to satellite service. e.g. A terrestrial eSIM be configured for use with 3rd party satellites. For instance, a cellular 3gpp sim is employed and a starlink eSIM may be deployed to the phone, wherein when using the app, the starlink sim may be used, but not the 3gpp sim or alternatively vice versa.

Certain network access may be limited to eSIM and certain applications are usable only on certain sims, e.g. usable while accessing certain networks. There may be an eSIM coded for wifi also, wherein certain applications are allowed to run on a wifi sim. Inter-network handover is allowed but only for certain applications.

In example embodiments, paypal pays for a subscription service on a satellite, but otherwise the phone has no access to satellite. So, when paypal needs to access a phone or set of user phones, the satellite link may be accessible, but not when the device has completed the payment transaction and received a response ack.

In this way, an app subscription may be co-loaded and coordinated with a network subscription. For example, a starlink or other satellite co. can sell applications and services that run on their network, e.g. run on their MEC, but may not actually have to separately sell a user an internet service since 99% of the time, the user may have wifi and 0.9% of the time the user may need terrestrial access.

A method performed by a phone, the method comprising: performing a bootstrap procedure to verify code of the phone; accessing the internet and receiving an application from an app store, wherein the application is configured to generate, for the phone, one or more eSIMs based on available networks to the eSIM, wherein at least one network is a satellite network, another network is a terrestrial network and yet another network is a satellite network; verifying the integrity of the downloaded eSIMs by the verified code of the phone, wherein the application either performs none, some or all of the verification; accessing an application server corresponding to the application, via one or more of the eSIMs; purchasing a product, based on one or more of the eSIMs, wherein one or more of the eSIMs are tied to a monetary account of the user of the phone.

US20240314549 to Mayalil is amended herein. A method for device-compatible electronic subscriber identity module (eSIM) profile provisioning to a wireless device, the method comprising: by a provisioning server: receiving, from a authentication party, a request message comprising an indication of supposed additional device capabilities to support one or more authentication features of a wireless communication standard; determining whether an eSIM profile corresponding to the indication of supposes additional device capabilities is actually available for provisioning to the wireless device; and sending, to the wireless device, an eSIM authentication profile when available, wherein the indication of additional device capabilities are associated with a satellite device capability and either associated with a non-3gpp satellite access system or associated with a 3gpp satellite access system.

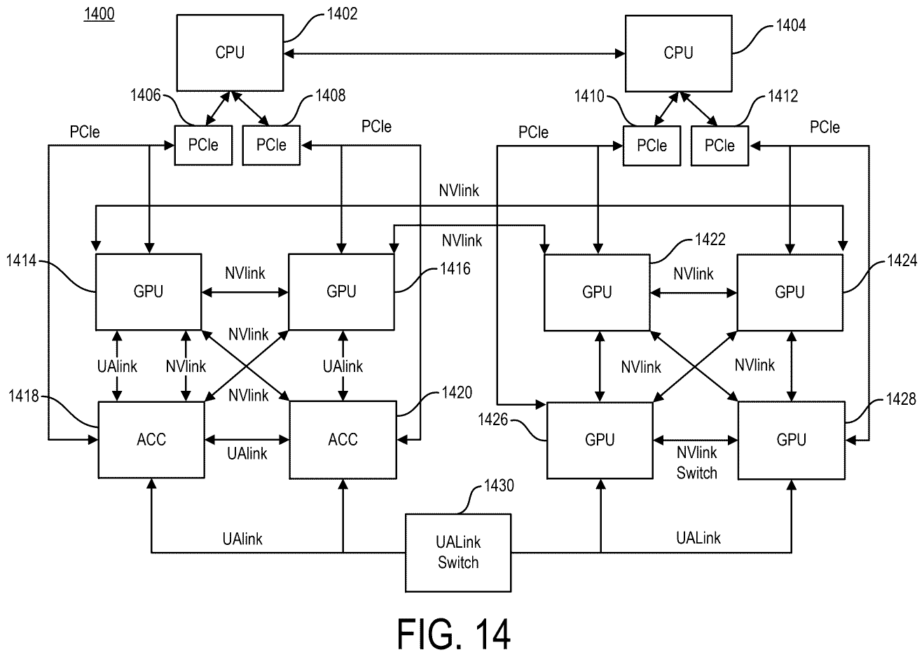

FIG. 14 is an illustration of UALINK switching embodiment 1400. In this embodiment, CPUs 1402, 1404 may be coupled with PCIe 1406, 1408 and PCIe 1410, 1412 respectively. GPUs 1414-1416 and ACC 1418-1420 may be NVlink coupled and/or UAlink coupled. GPUs 1422-1428 may be NVlink coupled. UAlink switch 1430 may provide a link between ACCs 1418, 1420 and GPUs 1426, 1428.

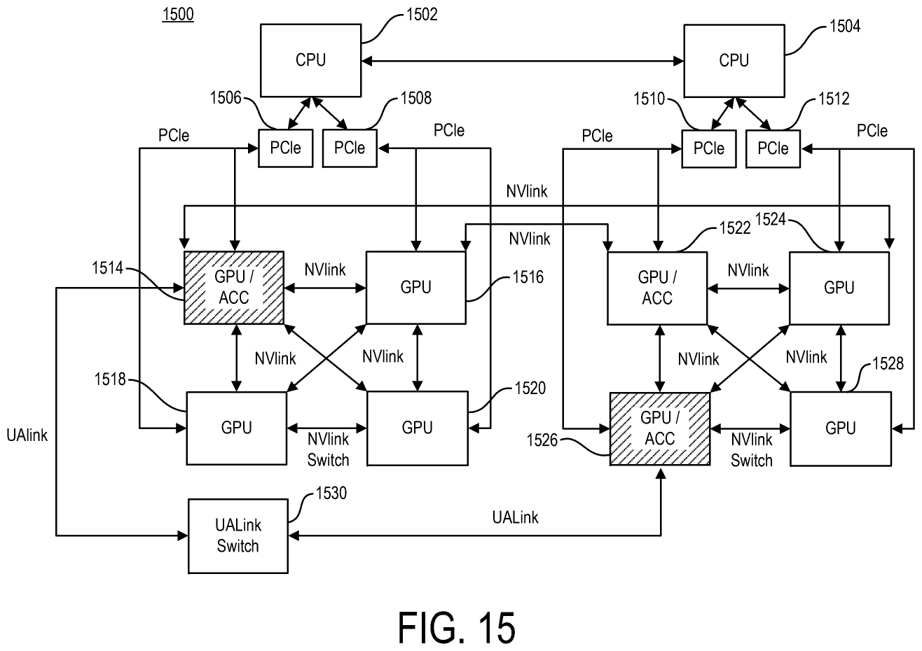

In embodiments, primary devices may be configured per the shading in FIG. 15.

FIG. 15 demonstrates UALink and NVLink interconnections 1500. In this embodiment, CPUs 1502, 1504 may be coupled with PCIe 1506, 1508 and PCIe 1510, 1512 respectively. GPUs 1514-1516 and ACC 1518-1520 may be NVlink coupled. GPUs 1522-1528 may be NVlink coupled. UAlink switch 1530 may provide a link between primary GPU/ACC 1514 and primary GPU/ACC 1526.

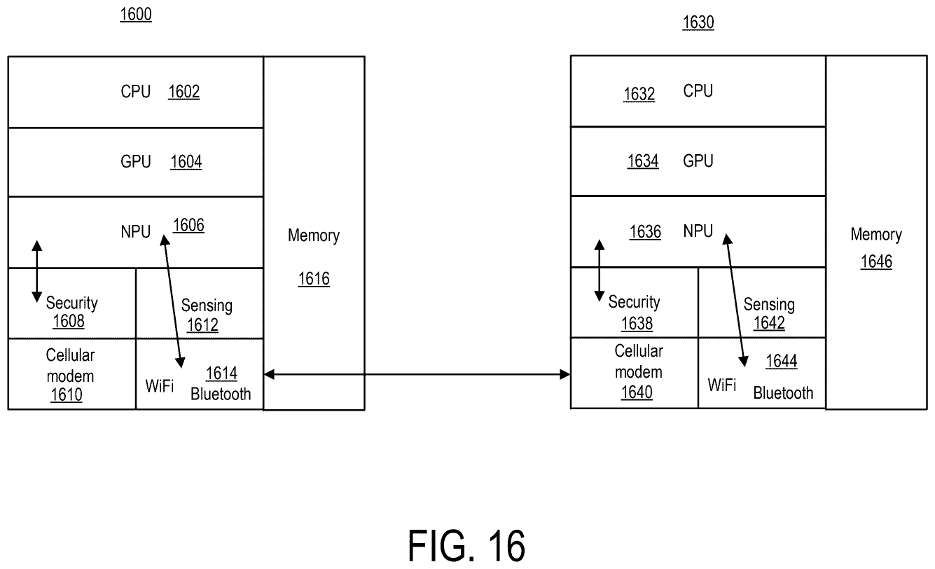

FIG. 16 illustrates two dedicated mobile processors 1600, 1630 which each have integrated NPUs 1606, 1636 respectively. The integrated NPUs 1606, 1636 may operate on a read write basis, similar to NVLink. Each CPU 1602, 1632 and security module 1608, 1638 may generate security parameters for sharing memory (certain memory components may be shared, while others not shared) between each coprocessor (running in separate UEs). Each UE may communicate via one or more of a cellular modem, wi-fi modem and/or a Bluetooth modem, and each technology may rely on same or different security parameters for reading/writing to memory in a corresponding UE. Specifically mobile processor 1600 may have a CPU 1602, GPU 1604, NPU 1606, security portion 1608, sensing portion 1612, cellular modem portion 1610 and wifi/Bluetooth portion 1614 along with memory 1616. Mobile processor 1630 may have a CPU 1632, GPU 1634, NPU 1636, security portion 1638, sensing portion 1642, cellular modem portion 1640 and wifi/Bluetooth portion 1644 along with memory 1646.

Each UE may report its capability to perform security key generation procedures and may exchange (negotiate) keying parameters along with time tables (eg. validity durations), memory size parameters. For instance, each UE may provide the other UE an estimated memory size, based on its available memory and based on a need for memory stored. In embodiments, virtual memory access may be employed, wherein each UE employs a virtual memory addressing space, which each UE maps to a physical memory space, the physical memory locations being unknown to the other UE. Each UE may receive connection parameters, memory parameters, security keys, and the like from one network, e.g. the cellular network or a satellite network, and may apply such parameters with respect to links on wi-fi, Bluetooth or the like. Security keys may not be known to each modems, for instance, if they are not known to the modems, it may be beneficial from a security perspective. Security parameters may be generated for use between the two UEs and a network element or a PC, laptop etc, such that the 3^{rd} device may have some control over the communication between the two UEs and itself. A trusted execution environment may operate on the UE, and once that execution environment is operable, it may receive parameters from a cellular network in order to form security keys used for authorizing read or write requests to memory locations (and not to other memory locations) as well as to potentially secure memory in another distributed system. Two trusted execution environments may negotiate parameters, e.g. via a wireless link, for controlling read and write requests on each devices shared GPU/NPU or other memory. The trusted execution environment may control which accelerators are allowed to communicate with which other accelerators, based on information received via the cellular network.

The same cellular network may also read one or more memory locations of an NPU of a UE and generate a first attested location vector (ALV) corresponding to one or more memory locations, wherein the first ALV comprises an attestation identifier, a timestamp corresponding to the read time, a location of the UE based on positioning and/or sensing signaling; and the cellular network may cooperate with a satellite network in an effort to convey attestation or non-attestation of the NPU to a device which is remote from the UE, wherein the remote device accesses shared memory of the UE based on the attestation; wherein the cellular network and/or satellite network provide certificate chain(s) corresponding to devices.

U.S. Pat. No. 12,137,176 to Wan is amended herein. A client-side electronic device for receiving satellite broadcast messages from a satellite communication network, comprising: a receiver configured for operable communication with a first message server over a communication medium of the communication network; a processor including a memory configured to store computer-executable instructions, which, when executed by the processor, cause the device to: receive, from the first message server, (i) a first satellite broadcast message of a plurality of satellite broadcast messages from satellites at different orbits, e.g. LEO and GEO, (ii) a first timestamp associated with the first satellite broadcast message, and (iii) a digital signature for the first satellite broadcast message and the first timestamp; verify an integrity of the first satellite broadcast message and the first timestamp based on the digital signature for the first satellite broadcast message and the first timestamp; determine a freshness of the first satellite broadcast message based on the received first timestamp; establish a trust state of the first satellite broadcast message based on the integrity verification and the freshness determination; and store the first broadcast message in the memory and in memory of another device (in embodiments of a UE in wireless communication which may or may not have satellite connectivity) along with the established trust state and an indication of the satellite characteristics including the orbit type, wherein the first satellite broadcast message includes a first unique sequence number of a series of sequence numbers, wherein the first unique sequence number distinguishes the first satellite broadcast message from other satellite broadcast messages in the plurality of satellite broadcast messages, and wherein the first timestamp is associated with the first satellite broadcast message based on the first unique sequence number, wherein the UE is adapted to trust one or more other messages received via the LEO and GEO satellites, based on parameters configured by the client-side electronic device.

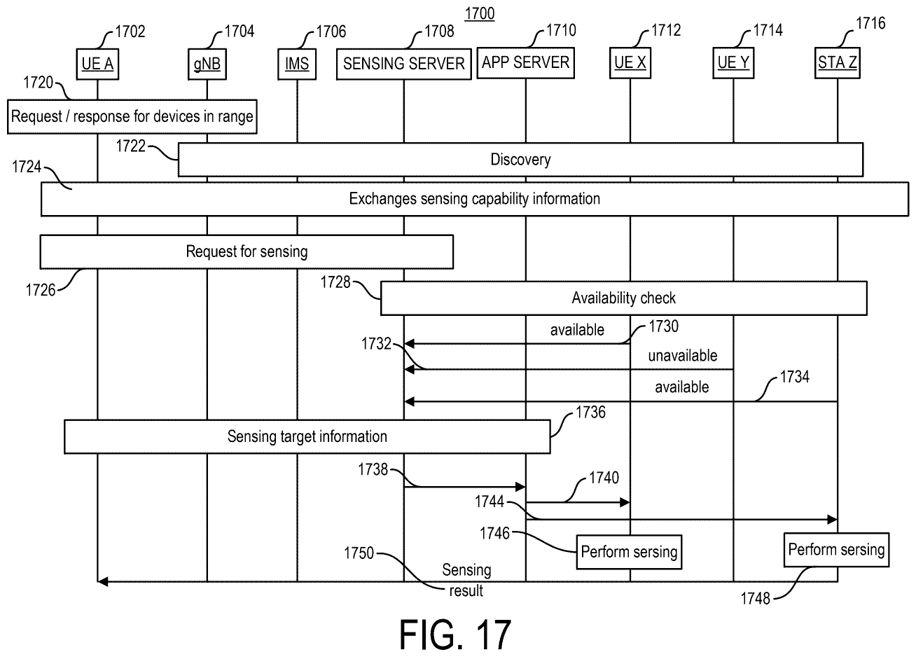

FIG. 17 is a diagram of an example sensing process 1700 involving a UE A 1702, gNB 1704, IMS 1706, sensing server 1708, app server 1710, UE X 1712, UE Y 1714 and STA Z 1716. UE A 1702 and gNB 1704 may exchange a request/response 1720 for devices in range. A discovery procedure 1722 may follow. An exchange of sensing capability information 1724 may occur on all devices or a subset thereof. A UE A 1702 may send a request for sensing 1726 to a sensing server 1708. An availability check 1728 may be performed by the sensing server 1708 and app server 1710 based on an availability of UE X 1712, UE Y 1714 and STA Z 1716. UE X 1712 may report available 1730. UE Y 1714 may report unavailable 1732 and STA Z may report available 1734. Sensing target information 1736 may be provided to the sensing server 1708 and app server 1710 for forwarding to UE x 1712 and STA Z 1716. UE X may perform sensing 1746 and STA Z may perform sensing 1748. The sensing result 1750 may be provided to UE A.

What is claimed is:

1. A method performed by a user equipment (UE) operating in a cellular network, the method comprising:
processing a subframe comprising downlink control information (DCI) having a variable size payload, wherein the DCI is located within 4 different symbols of the subframe, in time.

2. The method of claim 1, wherein the UE is bound to an independent network slice of the cellular network.

3. The method of claim 2, further comprising:
receiving key performance indicator (KPI) and/or key quality indicator (KQI) based parameters pertaining to the network slice.

4. A method performed by a first wireless device, the method comprising:
transmitting a SIP INVITE toward a second wireless device;
receiving information as to whether the second wireless device is reachable via a satellite having an altitude higher than a low earth orbital satellite, wherein the indication is received based in part on information obtained via a satellite network and in part based on information obtained via a terrestrial network; and
playing audio based on a latency of the satellite;
wherein a voice based media session is started between the first wireless device and the second wireless device, subsequent to the playing of the audio.

5. The method of claim 1, wherein the UE is bound to an independent network slice of the cellular network.

6. The method of claim 2, further comprising:
receiving key performance indicator (KPI) and/or key quality indicator (KQI) based parameters pertaining to the network slice.

7. A method performed by a base station, the method comprising:
transmitting a first synchronization signal block (SSB) comprising a primary synchronization signal (PSS), secondary synchronization signal (SSS) and a physical broadcast channel (PBCH);
transmitting a second SSB comprising another PSS, another SSS and another PBCH;
wherein the first SSB and the second SSB include a same number of resource elements dedicated to PSS;
wherein the second SSB is punctured, in comparison to the first SSB, wherein the puncture occurs subsequent in time to an initial synchronization symbol;
wherein the puncture is indicated to one or more UEs;
wherein the second SSB includes more symbols in time than the first SSB.

8. The method of claim 7, wherein the second SSB includes no fewer than 3 symbols of PBCH in the last three symbols of the second SSB.
